(19) United States
(12) Patent Application Publication
(10) Pub. No.: US 2006/0020572 A1
(43) Pub. Date: Jan. 26, 2006

(54) Computer, storage system, file management method done by the computer, and program

(76) Inventors: Yohsuke Ishii, Yokohama (JP); Mitsuru Ikezawa, Sagamihara (JP); Masaaki Iwasaki, Tokyo (JP); Yoji Nakatani, Yamato (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/954,075

(22) Filed: Sep. 30, 2004

(30) Foreign Application Priority Data
Jul. 21, 2004 (JP) 2004-212993

(51) Int. Cl. G06F 17/30

(52) U.S. Cl. 707/1

(57) ABSTRACT

An object of the present invention is to provide a list of information resources that are classified by the construction conditions requested by a user from the information resources stored in the storage device as the list of the information resources reflects the current information.

A control server 100 which is connected to one or more of storage devices 500 through a network 2 comprises:

means which accepts a construction condition for file data stored in the storage device 500; means which creates and stores information (virtual view information)that is associated with a file name and a stored location of the file data satisfying the construction condition; means which accepts a presentation request for the virtual view information from a user, and represents the stored virtual view information; means which updates the stored virtual view information when the file associated with the virtual view information is accessed.

This application relates to and claims priority from Japanese Patent Application, No. 2004-212993 filed on Jul. 21, 2004, the contents of which are incorporated herein by reference.

### BACKGROUND

The present invention relates to a technique which makes access to information resources stored in a computer system, particularly to a technique which shows information resources stored in a computer system as a grouped list to a user.

In recent years, with the realization of high-performance computer systems and reduction in costs, the use of computer systems is widely spreading in various businesses and purposes. In association with this, information resources having been handled as paper media before are also formed into electronic formats, and are electronically stored in computer systems. Furthermore, with the rapid progress in the use of the computer systems, information resources to be stored in the computer systems are dramatically increasing.

In the conventional computer systems, there is one that adopts a technique in which information resources are hierarchically classified and stored in accordance with predetermined classification conditions (for example, Japanese Patent Laid-open Publication No. 2003-316522,). Japanese Patent Laid-open Publication No. 2003-316522 discloses the technique that a plurality of computer systems is formed in clusters to construct a virtual view having a single hierarchical structure which classifies and stores information resources and the view is provided for a user. In Japanese Patent Laid-open Publication No. 2003-316522, the view technique is adopted to enhance the convenience of access to the information resources.

Moreover, conventionally, a technique in which information resources matching with specific classification conditions are searched from information resources stored in a storage system and the list of the searched information resources is shown to a user as a view (for example, WinFS API Session 2, searched on October 2003, <URL:http;//download.microsoft.com/download/6/6/9/669C5 6E3-12AF-48C5-AB2A-E7705F1BE37F/CLI321.ppt.>(hereinafter, called to as “Non-Patent Document 1”)) is known. In Non-Patent Document 1, the computer system accepts the classification conditions from a user, and performs a search request under the accepted classification conditions with respect to a plurality of storage systems having the information resources stored therein. The computer system receives search results that the plurality of the storage systems have searched, collects all the search results to create the information list matching with the classification conditions, and provides it for the user. According to Non-Patent Document 1, since the classification conditions can be set at every time of search, the user can obtain a dynamic view at every information that the user wants to search for. More specifically, according to the technique of Non-Patent Document 1, flexible information can be provided for each user.

### SUMMARY

In Patent Document 1 above, the information resources are stored in the computer system in accordance with the predefined classification conditions, and the list of the information resources stored at each of the classification conditions is provided as a view. On this account, Patent Document 1 has a problem that it is difficult to construct views classified by given classification conditions at each user. More specifically, when a view classified by different conditions from the predefined classification conditions is to be constructed by using the technique of Patent Document 1, files stored in the computer system need to be changed. Then, the task requires much effort and time. Particularly, when the computer system is large scale, the problem relating to the effort and time required for the task of changing the files is enormous.

In addition, Non-Patent Document 1 has the following problem. More specifically, the technique described in Non-Patent Document 1 performs a search process with respect to the information resources stored in the storage system at every time when accepting a presentation request for the view matching with the classification conditions desired by a user On this account, a problem occurs in Non-Patent Document 1 that it takes a long time until a view is provided from the time when the request is accepted from a user. Particularly, when information matching with the desired classification conditions is searched from a storage system where a massive volume of information resources is stored therein, the processing time for the search is increased to deteriorate the operational efficiency of a user.

Furthermore, the technique described in Non-Patent Document 1 requires a long time when searching for information matching with the classification conditions desired by the user as described above. On this account, when information resources stored in the storage system are registered and updated during the search process, it is unknown whether the view obtained by the search process is the data that reflects the registered and updated information in the information resources. That is, Non-Patent Document 1 cannot provide the view that reliably reflects the current data for the user.

Therefore there is a need to promptly provide a list of information resources that are classified by the classification conditions requested by a user from the information resources stored in the computer system as the list of the information resources reflects the current information.

The above need is met by a computer which is connected to one or more of storage devices through a network and performs access control over the storage device.

Then, the computer includes:

a means which accepts a classification condition for file data stored in the storage device;

a means which searches for file data satisfying the classification condition from the file data stored in the storage device, and creates and stores information that is associated with a file name and a stored location of the file data satisfying the classification condition at every classification condition (hereinafter, called to as “virtual view information”);

a means which accepts a presentation request for the virtual view information from a user, and represents the stored virtual view information;

a means which accepts an access request for the file data stored in the storage device from a user, and performs an access process with respect to the file data in the storage device; and

a means which updates the stored virtual view information when the-access process is done with respect to the file data.

As described above, according to the present invention, the computer creates the virtual view information that is associated with the file name and the stored location of the file data satisfying the classification condition at every classification condition having been accepted from the user about the file data stored in the storage device, and stores it beforehand. Therefore, according to the present invention, the information resources classified in accordance with the classification conditions requested from the user can be provided flexibly.

Furthermore, according to the present invention, when the user requests to show virtual view information, the virtual view information stored beforehand is represented. Thus, the request from the user can be answered promptly.

Moreover, according to the present invention, when the computer performs the access process with respect to the file data, the stored virtual view information is updated. More specifically, according to the present invention, the virtual view information is stored beforehand, and the stored virtual view information is updated as the access process is a cue when the access process is done with respect to the file data. Therefore, the virtual view information stored in the computer according to the present invention is stored as the access process is reflected therein.

Therefore, according to the present invention, when the user requests to show virtual view information, the virtual view information that reflects the current update state can be provided for the user.

### BRIEF DESCRIPTION OF THE DRAWINGS

The teachings of the present invention can be readily understood by considering the following detailed description in conjunction with the accompanying drawings, in which:

FIG. 1 is a diagram for describing the system configuration of a virtual view providing system of an embodiment according to the present invention;

FIG. 2 is an illustration depicting the exemplary hardware configuration of a control server of the embodiment according to the present invention;

FIG. 3 is a diagram schematically depicting an example of the data structure of a virtual view management table 2000 held by the control server of the embodiment according to the present invention;

FIG. 4 is an illustration depicting the exemplary hardware configuration of a storage node of the embodiment according to the present invention as an example;

FIG. 5 is an illustration depicting the exemplary hardware configuration of a client node of the embodiment according to the present invention;

FIG. 6 is a diagram for describing the correspondence between a virtual view provided by the embodiment according to the present invention and a file stored in the storage node;

FIG. 7 is a diagram depicting an example of input/output parameters used in a virtual view I/F control process of the embodiment according to the present invention;

FIG. 8 is a diagram depicting exemplary criteria which determine whether the virtual view of the embodiment according to the present invention needs to be registered and updated;

FIG. 9 is a diagram schematically depicting the data configuration of a file stored in the storage node of the embodiment according to the present invention;

FIG. 10 is a flow chart for describing an operational process for virtual view information done by the client node of the embodiment according to the present invention;

FIG. 11 is a flow chart for describing a virtual view access process done by the control server of the embodiment according to the present invention;

FIG. 12 is a diagram for describing the flow of a virtual view creation process done by the control server of the embodiment according to the present invention;

FIG. 13 is a flow chart for describing a virtual view construction condition setting process done by the control server 100 of the embodiment according to the present invention;

FIG. 14 is a flow chart for describing a virtual view update process done by the control server of the embodiment according to the present invention;

FIG. 15 is a flow chart for describing an information registration process and update process with respect to a virtual view management table done by the control server of the embodiment according to the present invention;

FIG. 16 is a flow chart for describing a virtual view acquisition process done by the control server of the embodiment according to the present invention;

FIG. 17 is a flow chart for describing a virtual view deletion process done by the control server of the embodiment according to the present invention;

FIG. 18 is a diagram for describing the flow of a virtual view update process as a file access operation done by the control server of the embodiment according to the present invention is a cue;

FIG. 19 is a flow chart for describing a virtual view update process as a file access operation done by the control server of the embodiment according to the present invention is a cue; and

FIG. 20 is a flow chart for describing an information deletion process from the virtual view management table done by the control server of the embodiment according to the present invention.

### DETAILED DESCRIPTION OF THE PREFERRED EMBODIMENTS

Hereinafter, a virtual view providing system to which an embodiment according to the present invention is applied will be described.

### First Embodiment

First, a first embodiment according to the present invention will be described.

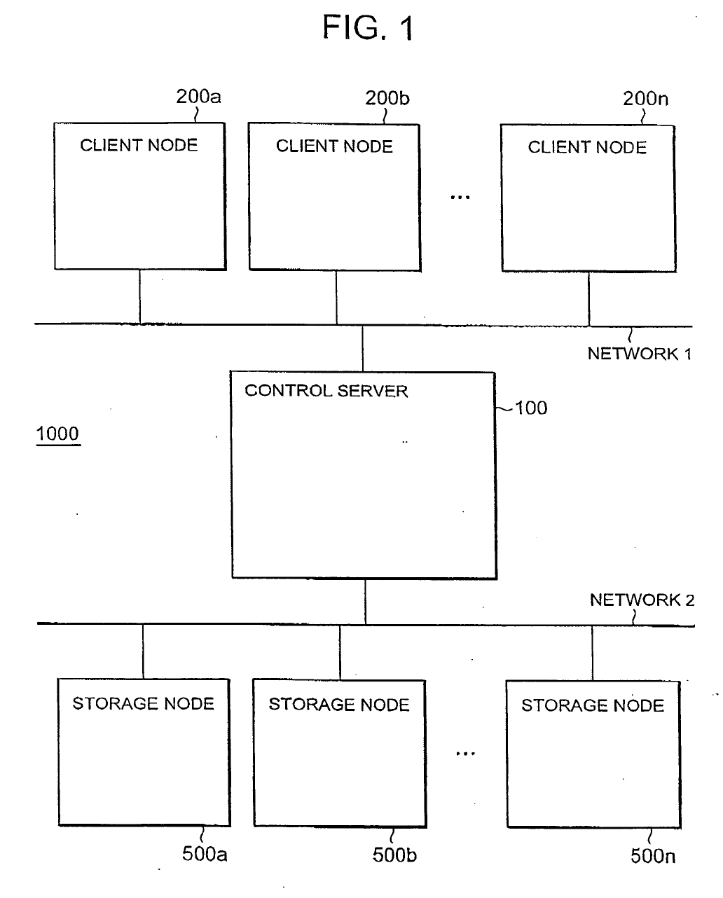

FIG. 1 is a diagram for describing the system configuration of a virtual view providing system of the first embodiment according to the present invention.

As shown in the drawing, a virtual view providing system 1000 has a control server (computer) 100, client nodes 200a to 200n, and storage nodes 500a to 500n. The control server 100 is connected to the individual client nodes 200a to 200n trough a network 1. Furthermore, the control server 100 is connected to the individual storage nodes 500a to 500n through a network 2.

The control server 100 manages file data (files) to be information resources that are stored in the storage nodes 500a to 500n in cooperation with the storage nodes 500a to 500n. More specifically, the control server 100 provides a file system function that manages the files for the client nodes 200a to 200n in cooperation with the storage nodes 500a to 500n.

Moreover, the control server 100 of the embodiment has a virtual-view function. The virtual view function is the function that groups ‘information showing file data’ including the file names and the stored locations of file data stored in the storage nodes 500a to 500n at every classification condition, which will be described later, stores the information grouped at every classification condition (hereinafter, called to as a “virtual view”), and provides the virtual view for the client nodes 200a to 200n. The virtual view function allows virtual views for individual clients to be constructed and provided for the client nodes 200a to 200n, not to provide the physical directory configuration of the file system as a single view.

The client nodes 200a to 200n use the file system function provided by the control server 100 and performs input/output processes of the file data stored in the storage node 100. More specifically, the client nodes 200a to 200n accept an access request for the files stored in the storage nodes 500a to 500n from a user. When the client nodes 200a to 200n accept the access request, they use the file system function and perform the access process with respect to the files stored in the storage nodes 500a to 500n. For example, when the accepted access request is a read process for the files, the client nodes 200a to 200n allow the control server 100 to do a readout request with respect to the files stored in the storage nodes 500a to 500n. The control server 100 reads the requested files out of the storage nodes 500a to 500n in accordance with the readout request. The control server 100 outputs the readout files to the client nodes 200a to 200n that have ordered the request. In this manner, the client node 200a to 200n can use the files stored in the storage nodes 500a to 500n through the control server 100.

The client nodes 200a to 200n use the virtual view function provided by the control server 100, and acquires the virtual views grouped at every classification condition. More specifically, the client nodes 200a to 200n accept the input of information showing the classification conditions from the user. The client nodes 200a to 200n output information showing the accepted classification conditions to the control server 100, and allows the control server 100 to create the ‘virtual views’ grouped at each of the accepted classification conditions. Further, the client nodes 200a to 200n accept a virtual view presentation request from the user. The client nodes 200a to 200n output the accepted virtual view presentation request to the control server 100, and acquire a virtual view from the control server 100. The client nodes 200a to 200n show the acquired virtual view to the user.

In addition, a specific method which the client nodes 200a to 200n show the virtual view to the user is not limited particularly. For example, a display device (not shown) may be connected to the client nodes 200a to 200n and the display device may be allowed to display a virtual view. Moreover, the client nodes 200a to 200n may have the configuration incorporated with the control server 100 in one piece. Any number of the client node 200a to 200n is acceptable.

The storage nodes 500a to 500n are devices that store the files to be information resources and store the files through the control server 100. In addition, the storage nodes 500a to 500n may be incorporated with the control server 100 in one piece. Any number of the storage nodes 500a to 500n is acceptable. For example, it is possible to construct a distributed file system by preparing a plurality of storage nodes to distribute and store files for storage in each of the storage nodes. Moreover, it is also possible to use a plurality of storage nodes based on a RAID (Redundant Array of Independent Disks) method to store information redundantly. Accordingly, it is possible as well to provide a file system more highly reliable and of higher performance than the use of a single storage node. The storage nodes 500a to 500n may be configured as a disk array system having a plurality of hard disks that forms a RAID group.

In addition, in the embodiment, the specific configuration of the network 1 and the network 2 is not defined particularly. The network 1 and the network 2 may be configured as the same network. Moreover, the network 1 and the network 2 may be configured as separate networks, for example, as the network 1 is configured of a LAN (Local Area network) and the network 2 is configured of a SAN (Storage Area network).

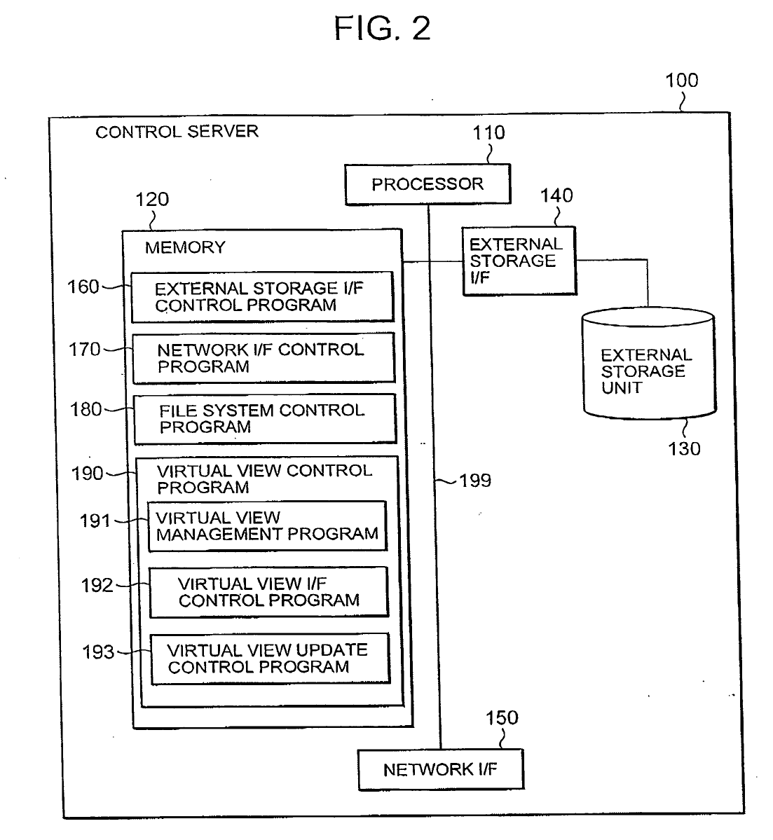

Next, the configuration of the control server will be described with reference to FIG. 2.

FIG. 2 is an illustration depicting the exemplary hardware configuration of the control server 100 of the embodiment.

The control server 100 has a processor 110 which executes programs, a memory 120 which temporarily stores programs and data therein, an external storage unit 130 which permanently stores programs and data therein, an external storage I/F 140 which makes access to the external storage unit 130, a network I/F 150 which makes access to the other units connected by the network, and a bus 199 which connects them.

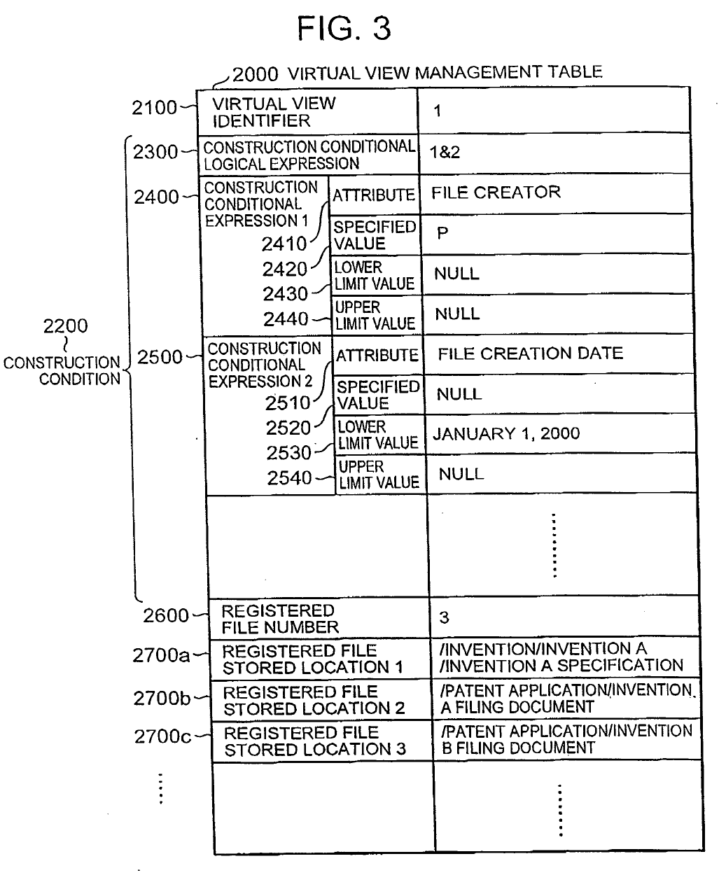

The external storage unit 130 and the memory 120 store an external storage I/F control program 160 which controls the external storage I/F 140, a network I/F control program 170 which controls the network I/F 150, a file system control program 180 which controls the file system function, and a virtual view control program 190 which controls the virtual view function therein. The virtual view control program 190 includes three programs: a virtual view management program 191, a virtual view I/F control program 192, and a virtual view update control program 193. In addition, in the external storage unit 130 and the memory 120, a virtual view management table 2000 (see FIG. 3) is stored. The individual programs are stored in the external storage unit 130 and read into a given area of the memory 120 by the processor 110. The virtual view management table 2000 is stored in the external storage unit 130 and read into a given area of the memory 120 by the processor 110.

In the embodiment, the example is taken that the individual programs are stored in the external storage unit 130 held by the control server 100, but the present invention is not limited thereto particularly. The individual programs may be stored in a storage medium. In this case, for example, the control server 100 is connected to an external unit that can read the individual programs stored in the storage medium. The processor 110 of the control server 100 may read the individual programs stored in the storage medium and may store them in the memory 120. In addition, for the storage medium, a volatile recording medium and a nonvolatile storage medium readable by the computer can be utilized, including a flexible disk, a CD-ROM, a DVD-ROM, a punch card, and printings printed with codes such as bar codes. The processor 110 of the control server 100 may download the individual programs to the memory 120 through a network such as the Internet.

The processor 110 performs various processes by executing the individual programs. More specifically, the processor 110 controls the external storage unit 140 by reading the external storage I/F control program 160 stored in the external storage unit 130 into a given area of the memory 120 for execution. Moreover, the processor 110 controls the network I/F 150 by reading the network I/F control program 170 stored in the external storage unit 130 into a given area of the memory 120 for execution. Similarly, the processor 110 provides the file system function by reading the file system control program 180 stored in the external storage unit 130 into a given area of the memory 120 for execution. Likewise, the processor 110 provides the virtual view function by reading the virtual view update control program 190 stored in the external storage unit 130 into a given area of the memory 120 for execution. The virtual view function is classified into a virtual view management function, a virtual view I/F control function, and a virtual view update control function.

The virtual view management function is implemented by executing the virtual view management program 191 by the processor 110 and that manages the virtual view management table 2000 (FIG. 3), which will be described later. The virtual view I/F control function is implemented by executing the virtual view I/F control program 192 by the processor 110 and that accepts an operation request for the virtual view, which will be described later, from the client nodes 200a to 200n and returns the result to the client nodes 200a to 200n to be the request source. The virtual view update control function reflects the processes such as file data update stored in the storage nodes 500a to 500n in the virtual view management table 2000 being managed. Moreover, the virtual view management function, the virtual view I/F control function and the virtual view update control function will be described later in detail.

The network I/F 150 is connected to the network 1 which connects the client nodes 200a to 200n to the control server 100 and the network 2 which connects the storage node 500a to 500n to the control server 100. Then, the control server 100 allows the client nodes 200a to 200n to communicate with the storage nodes 500a to 500n by the network I/F control program 170 through the network I/F 150.

Furthermore, when the control server 100 executes the process to provide the file system function, it controls the network I/F 150 by the network I/F control program 170 and accepts a file access request from the client nodes 200a to 200n. Moreover, when the control server 100 executes the process to provide the file system function, it controls the network I/F 150 by the network I/F control program 170 and performs a file access request with respect to the storage nodes 500a to 500n. In addition, the control server 100 performs an access request with respect to the storage nodes 500a to 500n in the request format that the storage nodes 500a to 500n can recognize target data.

Next, the virtual view management table 2000 which stores the virtual views will be described with reference to FIG. 3. In addition, the virtual view management table 2000 is a list or a data base that is managed by executing the virtual view management program 191 by the processor 110.

FIG. 3 is a diagram schematically depicting an example of the data structure of the virtual view management table 2000 held by the control server 100 of the embodiment.

As shown in the drawing, the virtual view management table 2000 has an entry 2100 which stores a virtual view identifier for identifying virtual views, an entry 2200 which stores construction conditions for the virtual view specified by the virtual view identifier stored in the entry 2100, an entry 2600 which stores the number of files registered in the virtual view specified by the virtual view identifier stored in the entry 2100, and entries 2700a to 2700c which store the stored locations of the registered files actually stored in the virtual view specified by the virtual view identifier stored in the entry 2100. Furthermore, the entry 2200 which stores the construction conditions is separated into an entry 2300 which stores a construction conditional logical expression for setting the construction conditions and entries 2400 and 2500 which store construction conditional expressions.

Into the entry 2300, a plurality of the construction conditional expressions that is stored in the entry 2400 and the entry 2500 and the construction conditional logical expression that defines the relationship between these construction conditional expressions can be registered. The method which defines the construction conditional logical expression to be stored in the entry 2300 is not limited particularly. For the construction conditional logical expression, for example, methods can be taken that can be expressed by logical expressions such as the negation of conditional expressions and the logical sum and the logical product of conditional expressions. In the example shown in the drawing, the logical product of the construction conditional expressions stored in the entry 2400 and the entry 2500 is defined.

The entry 2400 (2500) which stores the construction conditional expressions has an entry 2410 (2510) which stores an attribute, an entry 2420 (2520) which stores a specified value, an entry 2430 (2530) which stores a lower limit value, and an entry 2440 (2540) which stores an upper limit value. In addition, the lower limit value and the upper limit value are to be used as a set, and either the specified value or a set of the lower limit value and the upper limit value is used.

In the example shown in the drawing, the construction conditional expression 1 of the entry 2400 has a ‘file creator’ stored in the entry 2410 which stores the attribute, a valid value ‘P’ stored in the entry 2420 which stores the specified value, ‘NULL’ meaning an invalid value stored in the entries 2430 and 2440 which store the lower limit value and the upper limit value. That is, the construction conditional expression 1 stored in the entry 2400 shows that the file creator sets all the files to be ‘P’ as the construction condition for the virtual view.

Furthermore, when a set of the upper limit value and the lower limit value is used as the construction conditional expression, a valid value consistent to the both values is set. Here, it is possible to specify an infinite range in one direction by setting an invalid value to only one of the upper limit value and the lower limit value.

The construction conditional expression 2 stored in the entry 2500 has a ‘file creation date’ stored in the entry 2510 which stores the attribute, and ‘NULL’ meaning the invalid value stored in the entry 2520 which stores the specified value. Moreover, a valid value of ‘Jan. 1, 2000’ is stored in the entry 2530 which stores the lower limit value, and ‘NULL’ meaning the invalid value is stored in the entry 2540 which stores the upper limit value. The construction conditional expression 2 stored in the entry 2500 shows that the entire file data created after ‘Jan. 1, 2000’ is set as the construction condition for the virtual view.

In addition, the method which sets the construction conditions for the virtual view is not limited to the method shown in FIG. 3. For example, a logical expression formed of the construction conditional expression and the construction conditional logical expression in one piece may be registered as the construction condition. For the attribute used in the construction conditional expression, there are various ones such as file attribute information and actual file information. For example, a ‘keyword’ included in the actual file information may be set as the construction condition. Moreover, the ‘keyword’ included in the actual file information maybe combined with the ‘file attribute information’ as the construction condition. Besides, the file attribute information and the actual file information will be described later.

As described above, the entry 2600 stores the number of files registered into the virtual view which matches with the construction condition for the virtual view therein. Then, the number of the entries 2700a to 2700c of the virtual view management table 2000 is secured as equal to the number of registered files. In the example shown in the drawing, ‘3’ is stored in the entry 2600 which stores the number of registered files therein. On this account, three entries (2700a to 2700c) are secured in the virtual view management table 2000 as the registered file stored locations.

The registered file stored location to be stored in the entries 2700a to 2700c stores identification information about a registered file therein, that is, information required to make access to that file. More specifically, a path name/file name may be registered as the registered file identification information; the name is used by the file system function implemented by the file system control program of the control server 100 when making access to the storage nodes 500a to 500n. For the registered file identification information, a path name/file name may be registered as storage node identification information; the name is that the storage nodes 500a to 500n make access through the local file system control program. In the example shown in the drawing, the path name/file name of the registered file is stored in the registered file stored location stored in the entries 2700a to 2700c, in accordance with the former method. More specifically, ‘/Invention/Invention A/Invention A Specification’ is stored in the entry 2700a, ‘/Patent Application/Invention A Filing Document’ is stored in the entry 2700b, and ‘/Patent Application/Invention B Filing Document’ is stored in the entry 2700c.

In addition, the data structure of the virtual view management table 2000 described above is merely an example. For example, the entries of the construction conditions and the entries of the registered file stored locations may be formed in another table and only reference information to that another table may be registered into the virtual view management table. Furthermore, in the embodiment, the example is taken that the control server 100 holds the virtual view management table 2000, but the present invention is not limited thereto particularly. The storage nodes 500a to 500n may be allowed to hold the virtual view management table 2000.

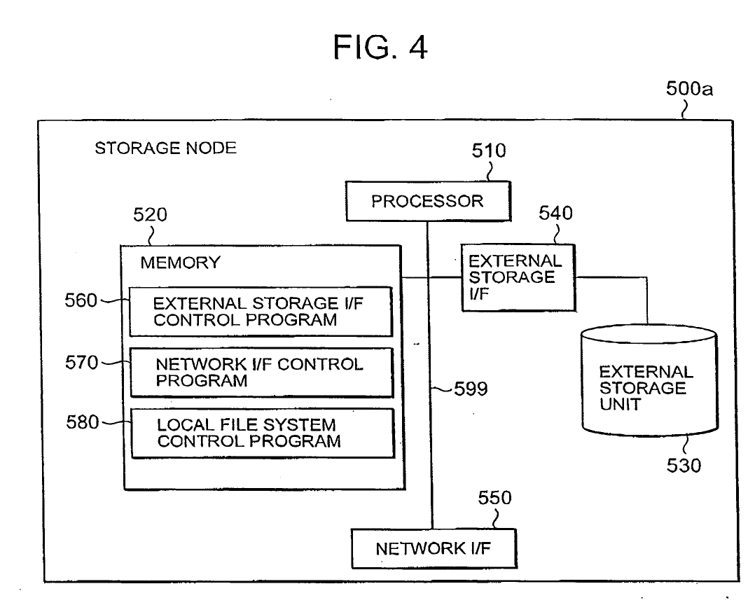

Next, the hardware configuration of the storage nodes 500a to 500n will be described with reference to FIG. 4.

FIG. 4 is a diagram for describing the hardware configuration of the storage node 500a of the embodiment. In addition, since the storage nodes 500b to 500n have the same configuration as that of the storage node 500a, the description is omitted.

The storage node 500a has a processor 510 which executes programs, a memory 520 which temporarily stores programs and data therein, an external storage unit 530 which permanently stores programs and data therein, an external storage I/F 540 which makes access to the external storage unit 520, a network I/F 550 which makes access to the other units connected by the network, and a bus 599 which connects them.

The external storage unit 530 and the memory 520 store an external storage I/F control program 560 which controls the external storage I/F 540, a network I/F control program 570 which controls the network I/F 550, a local file system control program 580 which controls file data in the storage node 500a therein. More specifically, the individual programs are stored in the external storage unit 530 and read into a given area of the memory 520 by the processor 510.

In addition, in the embodiment, the example is taken that the individual programs are stored in the external storage unit 530 held by the storage node 500a, but the present invention is not limited thereto particularly. The individual programs may be stored in a storage medium. In this case, for example, the storage node 500a is connected to an external unit that can read the individual programs stored in the storage medium. The processor 510 of the storage node 500a may read the individual programs stored in the storage medium and stores them in the memory 520. In addition, for the storage medium, a volatile recording medium and a nonvolatile storage medium readable by the computer can be utilized, including a flexible disk, a CD-ROM, a DVD-ROM, a punch card, and printings printed with codes such as bar codes. The processor 510 of the control server 500a may download the individual programs to the memory 520 through a network such as the Internet.

The processor 510 performs various processes by executing the individual programs. More specifically, the processor 510 controls the external storage I/F 540 by reading the external storage I/F control program 560 stored in the external storage unit 530 into a given area of the memory 520 for execution. Moreover, the processor 510 controls the network I/F 550 by reading the network I/F control program 570 stored in the storage unit 530 into a given area of the memory 520 for execution. Besides, the processor 510 reads the local file system control program 580 stored in the external storage unit 530 into a given area of the memory 520 for execution, and thus utilizes the external storage unit 530 on the storage node 500a thereof to construct the file system. That is, the processor 510 performs the access process to the file data stored in the external storage unit 530 of the storage node 500a thereof by the local file system control program 580.

The network I/F 550 is connected to the network 2 that is connected to the control server 100. Then, the storage node 500a communicates with the control server 100 by the network I/F control program 570 through the network I/F 550.

Furthermore, in performing the access process with respect to local file data, the storage node 500a accepts an access request from the control server 100 through the network I/F 550 controlled by the network I/F control program 570. The access request is performed in the format that can recognize the file data on the storage node 500a. Moreover, the specific format of the access request is not limited particularly. For example, the access request in the format that utilizes the path name/file name of the file used by the storage node 500a when performing the access process with respect to local file data may be accepted. Then, the result of the access request is returned from the storage node 500a to the control server 100 in the reverse procedures to the procedures when requested.

The external storage unit 530 is the apparatus that stores file data managed by the local file system control program 580. In addition, the specific configuration of the external storage unit 530 is not limited particularly, but for example, a hard disk may be used for the external storage unit 530. Also, the external storage unit 530 may be configured of a plurality of hard disks.

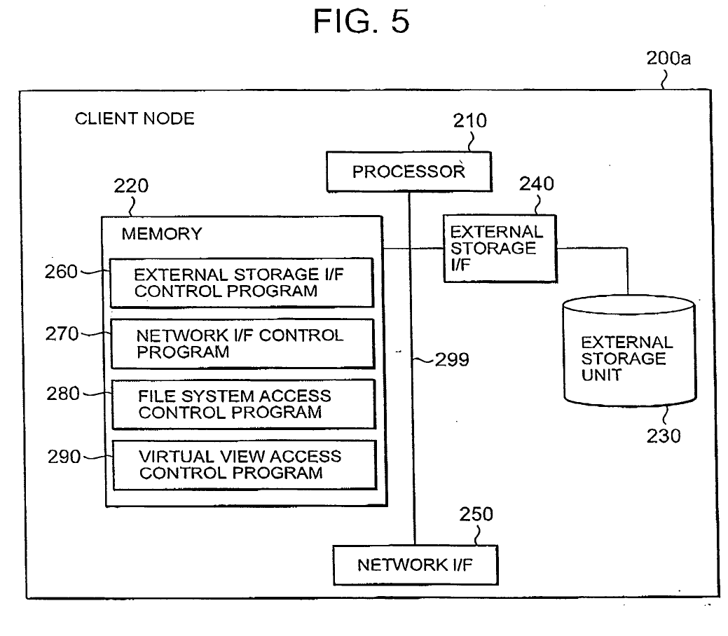

Next, the hardware configuration of the client nodes 200a to 200n will be described with reference to FIG. 5.

FIG. 5 is a diagram for describing the hardware configuration of the client node 200a of the embodiment. In addition, since the client nodes 200b to 200n have the same configuration of that of the client node 200a, the description is omitted.

As shown in the drawing, the client node 200a has a processor 210 which executes programs, a memory 220 which temporarily stores programs and data therein, an external storage unit 230 which can permanently store programs and data therein, an external storage I/F 240 which makes access to the external storage unit 230, a network I/F 250 which makes access to the other units connected by the network, and a bus 299 which connects them.

The external storage unit 230 and memory 220 store an external storage I/F control program 260 which controls the external storage I/F 240, a network I/F control program 270 which controls the network I/F 250, a file system access control program 280 which makes access to the file system function provided by the control server 100, and a virtual view access control program 290 which uses the virtual view function provided by the control server 100 therein. More specifically, the individual programs are stored in the external storage unit 230 and read into a given area of the memory 220 by the processor 210.

Furthermore, in the embodiment, the example is taken that the individual programs are stored in the external storage unit 230 held by the client node 200a, but the present invention is not limited thereto. The individual programs may be stored in a storage medium. In this case, for example, the client node 200a is connected to an external unit that can read the individual programs stored in the storage medium. Then, the processor 210 of the client node 200a may read the individual programs stored in the storage medium and may store them in the memory 220. In addition, for the storage medium, a volatile recording medium and a nonvolatile storage medium readable by the computer can be utilized, including a flexible disk, a CD-ROM, a DVD-ROM, a punch card, and printings printed with codes such as bar codes. Moreover, the processor 210 of the client node 200a may download the individual programs to the memory 220 through the network such as the Internet.

The processor 210 performs various processes by executing the individual programs. More specifically, the processor 210 controls the external storage I/F 240 by reading the external storage I/F control program 260 stored in the external storage unit 230 into a given area of the memory 220 for execution. In addition, the processor 210 controls the network I/F 250 by reading the network I/F control program 270 stored in the external storage unit 230 into a given area of the memory 220 for execution. Besides, the processor 210 reads the file system access control program 280 stored in the external storage unit 230 into a given area of the memory 220 for execution, and thus utilizes the file system function provided by the control server 100. Moreover, the processor 210 reads the virtual view access control program 290 stored in the external storage unit 230 into a given area of the memory 220 for execution, and thus utilizes the virtual view function provided by the control server 100.

By the file system access control program 280, the processor 210 makes access to the files in the storage nodes 500a to 500n through the control server 100, and performs the access process including a read process, a write process, and a deletion process with respect to file data. Furthermore, by the virtual view access control program 290, the processor 210 performs various requests including a creation request for the virtual view management table 2000 (see FIG. 3), which will be described later, and a virtual view acquisition request, with respect to the control server 100. Moreover, by the virtual view access control program 290, the processor 210 acquires information returned from the control server 100 and shows it to the user in accordance with the requests.

The network I/F 250 is connected to the network 1 that is connected to the control server 10. Then, by the network I/F control program 270, the client node 200a communicates with the control server 100 through the network I/F 250 The access process with respect to the control server 100 executed by the file system access control program 280 is performed through the network I/F 250 that is controlled by the network I/F control program 270.

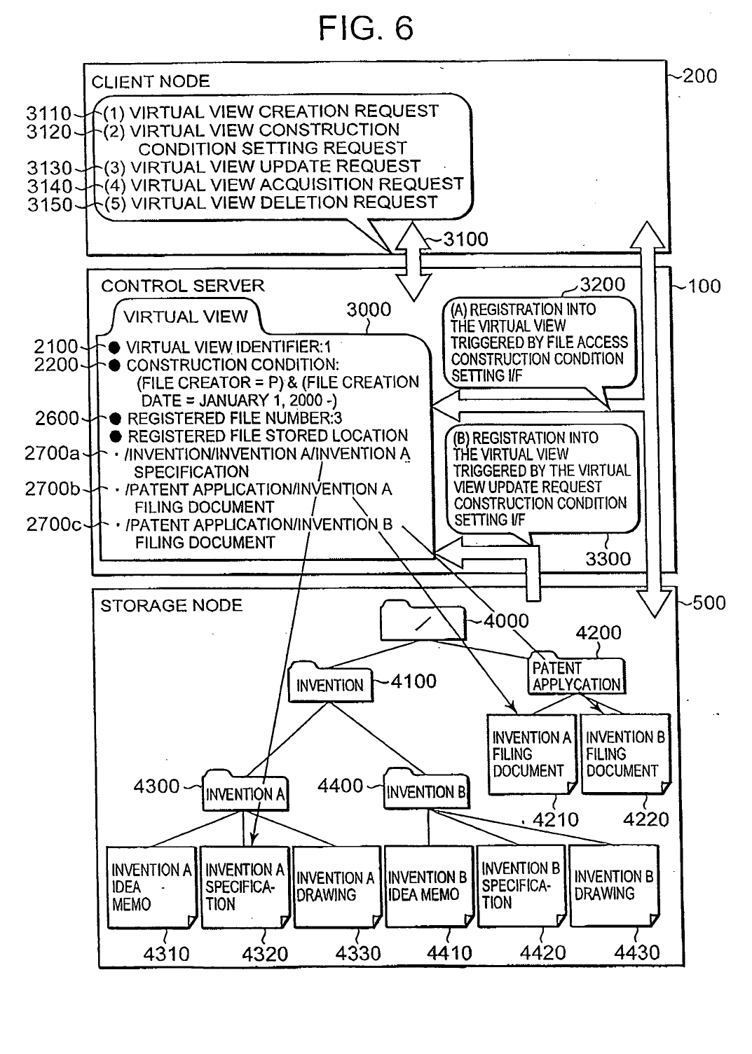

Next, the correspondence between the virtual view provided by the virtual view providing system of the embodiment and the file data stored in the storage nodes 500a to 500n will be described with reference to FIG. 6.

FIG. 6 is a diagram for describing the correspondence between the virtual view provided by the control server of the embodiment and the file data stored in the storage node.

As shown in the drawing, a virtual view 3000 is placed on the control server 100, and file data is stored in the storage node 500. The virtual view 3000 is that the virtual view shown as the virtual view management table 2000 in FIG. 3 is typified. The control server 100 accepts a virtual view acquisition request from the client nodes 200a to 200n, and outputs information showing the contents of the virtual view 3000 to the client nodes 200a to 200n. The client nodes 200a to 200n represent the information shown in the virtual view 3000 to the user. Furthermore, by the virtual view access control program 290, the client nodes 200a to 200n can make access to the files shown in the virtual view 3000 through the control server 100. More specifically, by the virtual view access control program 290, the client nodes 200a to 200n send an access request that specifies the file shown in the virtual view 3000 to the control server 100. By the file system control program 180, the control server 100 uses information registered in the registered file stored locations 2700a to 2700c in the virtual view management table 2000, and makes access to the file for which the access request has been made.

Moreover, a plurality of virtual views 3000 can be created in the control server 100. Besides, it is acceptable to register a single file into a plurality of virtual views. In addition, when there is a plurality of storage nodes, the virtual view 3000 which targets the files stored on each of the storage nodes, that is, the virtual view extended over the storage nodes can be created.

In the example shown in the drawing, the directory structure of the file system function provided on the storage nodes 500a to 500n has a route directory ‘/’ 4000 as its top. For subdirectories of the route directory ‘/’ 4000, there are an ‘Invention’ directory 4100 and a ‘Patent Specification’ directory 4200. In the ‘Invention’ directory 4100, there are an ‘Invention A’ directory 4300 and an ‘Invention B’ directory 4400 as its subdirectories. In the ‘Invention A’ directory 4300, there are three files: an ‘Invention A Idea Memo’ 4310, an ‘Invention A Specification’ 4320, and an ‘Invention A Drawing’ 4330. Similarly, in the ‘Invention B’ directory 4400, there are three files: an ‘Invention B Idea Memo’ 4410, an ‘Invention B Specification’ 4420, and an ‘Invention B Drawing’ 4430. Furthermore, in the ‘Patent Application directory’ 4200, there are two files: an ‘Invention A Filing Document’ 4210, and an ‘Invention B Filing Document’ 4220.

The virtual view 3000 shown in the drawing is the file that the virtual view identifier 2100 is ‘1’, the file creator is ‘P’ in the construction condition 2200, and the file creation date is ‘after Jan. 1, 2000’. Moreover, the virtual view 3000 shows the registered file number 2500 as ‘3’, and the ‘path names/file names’ for three files as the registered file stored locations 2700a to 2700c corresponding to the registered files. More specifically, the registered file stored location 2700a where the registered file name is the ‘Invention A Specification’ 4320 is ‘/Invention/Invention A/Invention A Specification’. The registered file stored location 2700b where the registered file name is the ‘Invention A Filing Document’ 4210 is ‘/Patent Application/Invention A Filing Document’ The registered tile stored location 2700c where the registered file name is the ‘Invention B Filing Document’ 4220 is ‘/Patent application/Invention B Filing Document’.

Next, the I/F (virtual view operation I/F) which allows the user to use the virtual view 3000 of the embodiment will be described with reference to FIG. 6.

By the virtual view I/F control program 192, the control server 100 provides a virtual view operation I/F 3100 for the user through the client nodes 200a to 200n. The operational process accepted from the user by the virtual view operation I/F 3100 has five operational processes: a virtual view creation request 3110, a virtual view construction condition setting request 3120, a virtual view update request 3130, a virtual view acquisition request 3140, and a virtual view deletion request 3150. In addition, the specific process flow of these five processes will be described later.

Subsequently, parameters will be described that are used in the five operational processes (3110, 3120, 3130, 3140 and 3150) which the control server 100 accepts from the user by the virtual view I/F control program 192.

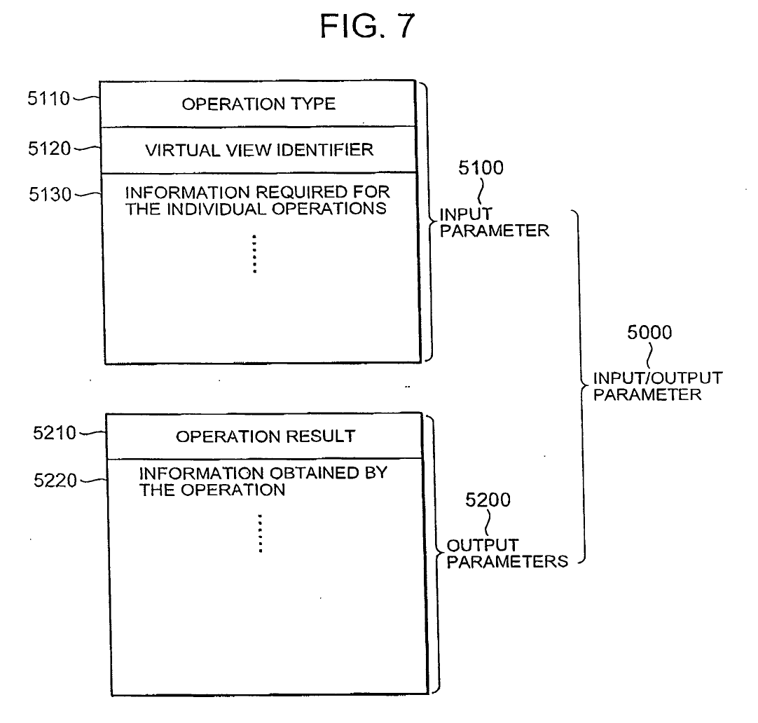

FIG. 7 is a diagram illustrating an example of input/output parameters used by the control server of the embodiment.

The input/output parameter 5000 shown in the drawing includes an input parameter 5100 and an output parameter 5200.

The input parameter 5100 includes an operation type 5110 which identifies which virtual view operation is to be done, a virtual view identifier 5120 which identifies a virtual view to be an operation target, and information 5130 required for the individual operations.

The operation type 5110 stores information which identifies the five operational processes (3110, 3120, 3130, 3140 and 3150) provided by the virtual view I/F control program 192 therein. The information 5130 required for the individual operations is varied depending on the individual operations. For example, the information 5130 required for the individual operations stores the virtual view construction condition therein in the case of the virtual view creation request 3110 and the virtual view construction condition setting request 3120. For the storage format of the construction condition, a format can be considered that follows the construction condition 2200 in the virtual view management table 2000. However, it is acceptable to use the other formats not based on this format.

The output parameter 5200 includes an operation result 5210 which tells the result of the requested operation, and information 5220 which is obtained by the operation. The operation result 5210 stores information showing whether the operation is successful or failed therein. Furthermore, the operation result 5210 stores information showing that what reason causes the failure when the operation is failed therein. The information 5220 obtained by the operation is varied depending on the individual operations. For example, the information 5220 obtained by the operation stores the identifier for the created virtual view therein in the case of the virtual view creation request 3110. Moreover, for example, the information 5220 obtained by the operation stores information therein managed by the virtual view management table 2000 in the case of the virtual view acquisition request 3140. In addition, in this case, all the information in the virtual view management table 2000 or to store only a part of information may be stored.

Next, the cue will be described by which the control server 100 of the embodiment updates the virtual view (information stored in the virtual view management table 2000). There are two cues for virtual view update: the cue that triggers the file access operation for the storage nodes 500a to 500n (an update cue 3200), and the cue that triggers the virtual view update request 3130 (an update cue 3300) (see FIG. 6). Then, the control server 100 updates the contents of the virtual view management table 2000 held therein by the two cues. More specifically, the control server 100 performs the update process for the virtual view management table 2000 when it performs the access process with respect to the file data in the storage nodes 500a to 500n. Moreover, the control server performs the update process for the virtual view management table 2000 when it accepts the virtual view update request 3130 from the user through the client nodes 200a to 200n. In addition, the specific process flow to update the virtual view management table 2000 in the two update cues will be described later.

Subsequently, the update of the virtual view will be described that is triggered by the file access operation with respect to the files stored in the storage nodes 500a to 500n as a cue (the update cue 3200).

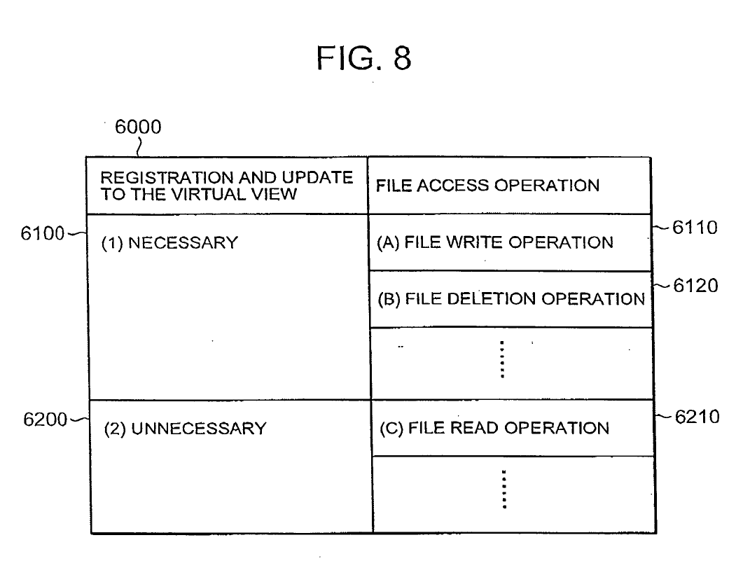

The control server 100 determines whether the virtual view requires update in accordance with the types of access when it makes access to the files in the storage nodes 500a to 500n. Here, the criteria that the control server 100 determines whether the virtual view requires update will be described with reference to FIG. 8.

FIG. 8 is a diagram illustrating the exemplary criteria which determine whether the virtual view needs to be registered and updated.

In a list 6000, file access operations are classified in view whether the virtual view needs to be updated in the virtual view update.

In the list 6000 shown in the drawing, a file write operation 6110 and a file deletion operation 6120 are named as the file access operation 6100 that requires the virtual view update. The reason why the file operations are the target for update is that the file operations are the processes to change the contents of the files stored in the storage nodes 500a to 500n. In addition, not shown in the drawing, the file access operation 6100 for the virtual view that requires update includes a file creation operation, a directory creation operation, a directory deletion operation, a directory information setting operation, a file name/directory name renaming operation, a file/directory copy operation, a file/directory transfer operation, a file link creation operation, a file link deletion operation, a synchronous operation which synchronously writes information being written, and an operation to close a file.

Furthermore, a file read operation 6210 is named as a file access operation 6200 that does not require virtual view update. This is because this file operation is not the process to change the contents of the files stored in the storage nodes 500a to 500, and the virtual view does not require update. Moreover, not shown in the drawing, the file access operation 6200 which does not require virtual view update includes a file opening operation, a file attribute acquisition operation, a directory information acquisition operation, a file authority access confirmation operation, a file link information read operation, and a file information acquisition operation.

Next, the data configuration of the files stored in the storage nodes 500a to 500n of the embodiment will be described.

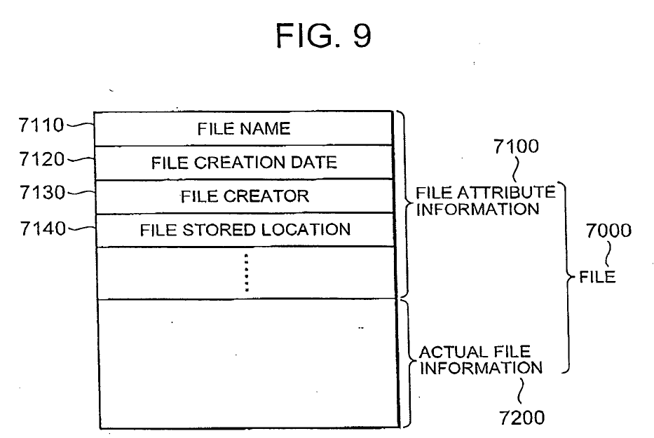

FIG. 9 is a diagram schematically depicting the data configuration of the file stored in the storage node of the embodiment.

As shown in the drawing, a file 7000 has file attribute information 7100 and actual file information 7200. The file attribute information 7100 corresponds to meta contents of this file. The file attribute information 7100 includes a file name 7110, a file creation date 7120, a file creator 7130, and a file stored location 7140. Furthermore, not shown in the drawing, it is acceptable that the file attribute information 7100 includes information, such as physically stored location information about the file, access control information, a file owner, an affiliation group, a size, the last access time, the last update time, the last change time, a size of the storage area physically used, and a keyword.

Moreover, the file attribute information is classified into two: a ‘system attribute’ that is managed by the file system control program 180, and a ‘user attribute’ that is the attribute registered and updated in accordance with the request accepted from the user and is managed only by the file system control program 180. Besides, the attribute handled as the system attribute is determined by the file system control program 180. The attribute handled as the user attribute can be expanded by the user as well.

The-actual file information 7200 corresponds to a byte stream of actual data of a file. The actual file information 7200 is stored in the external storage unit 530 on the storage node 500. For the file attribute information 7100, a method cane considered in which it is stored in the external storage unit 130 on the control server 100, other than a method in which it is stored in the external storage unit 530 on the storage node 500. Here, information to be stored in the storage node 500a can be stored in the storage nodes 500b to 500n similarly.

In addition, the file write operation 6110 and the file read operation 6210 correspond to both operations for the file attribute information 7100 and the actual file information 7200 shown in FIG. 9. The operations of changing the file name 7110 and changing the file stored location 7140 correspond to the file write operation 6110 for the file attribute information 7100. An overwrite update operation to real data corresponds to the file write operation 6110 for the actual file information 7200. On the other hand, a reference operation for the file attribute information 7100 and the actual file information 7200 corresponds to the file readout operation 6210.

Furthermore, the file deletion operation 6120 corresponds to the operation for the file 7000. That is, the file deletion operation 6120 means that the file attribute information 7100 and the actual file information 7200 about the file 7000 are deleted. The operation of deleting the entire actual file information 7200 or partially deleting the file attribute information 7100 or the actual file information 7200 is considered to be the file write operation 6110.

In the embodiment, the virtual view is updated in the cases where the file write operation 6110 is performed and the file deletion operation 6120 is performed with respect to the file attribute information 7100 and the actual file information 7200. Moreover, for the file write operation 6110, there are the cases where a file 7000 is newly stored, and a part of the file attribute information 7100 is changed. For example, there is the case where the file stored location 7140 is changed.

Next, the operational process for virtual view information will be described that the client nodes 200a to 200n of the embodiment perform with respect to the control server 100.

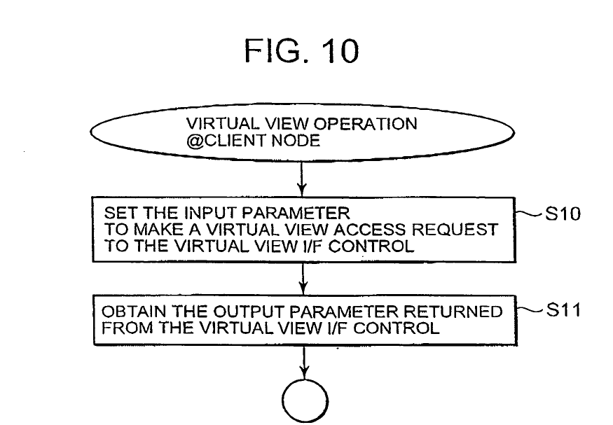

FIG. 10 is a flow chart for describing the operational process for the virtual view information done by the client node of the embodiment.

In addition, the process below is implemented by executing the virtual view access control program 290 by the processor 210 of the client nodes 200a to 200n. However, the virtual view access control program 290 is mainly described below for simplifying the description.

The virtual view access control program 290 accepts an operation request from the user. More specifically, the virtual view access control program 290 accepts the input parameter 5100 (see FIG. 7) from the user. The virtual view access control program 290 creates a virtual view operation request where the accepted input parameter 5100 is set as an argument. The virtual view access control program 290 outputs the virtual view operation request where the input parameter 5100 is set therein to the control server 100 (S10).

In addition, in the embodiment, a means which accepts the input of the operation request from the user is not limited particularly. For example, the virtual view access control program 290 may display an operation menu screen on a display device, not shown, and may accept the input of the operation request from the user.

By the virtual view I/F control program 192, the control server 100 having accepted the virtual view operation request performs the process matching with the accepted virtual view operation request, and outputs information showing the result to the virtual view access control program 290. The information showing the result is considered to include the output parameter 5200 (see FIG. 7). Furthermore, the process for the virtual view operation request accepted by the control server 100 will be described later.

Then, the virtual view access control program 290 receives the information showing the result from the control server 100, and represents the output parameter 5200 included in the information to the user (S11).

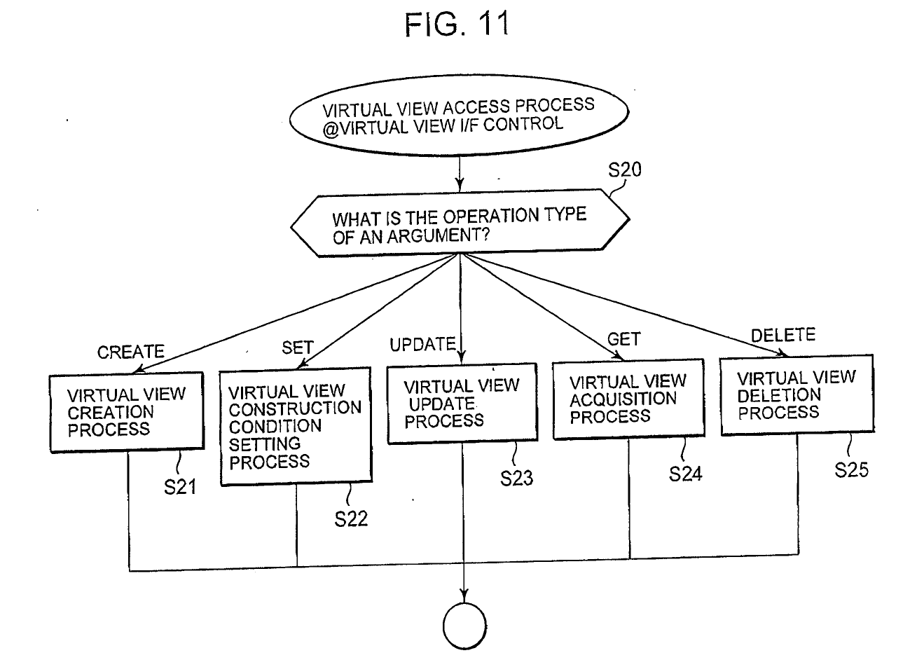

Next, the virtual view access process done by the control server 100 of the embodiment will be described with reference to FIG. 11.

FIG. 11 is a flow chart for describing the virtual view access process done by the control server 100 of the embodiment.

In addition, the process below is implemented by executing the individual programs (the virtual view I/F control program 192, the virtual view management program 191, and the virtual view update control program 193) by the processor 110 of the control server 100. However, the individual programs (the virtual view I/F control program 192, the virtual view management program 191, and the virtual view update control program 193) are mainly described below for simplifying the description.

The virtual view I/F control program 192 accepts the virtual view operation request outputted from the client nodes 200a to 200n. The virtual view I/F control program 192 refers to the input parameter 5100 (FIG. 7) that is set as the argument in the accepted virtual view operation request, and determines the operation type of the accepted operation request (S20).

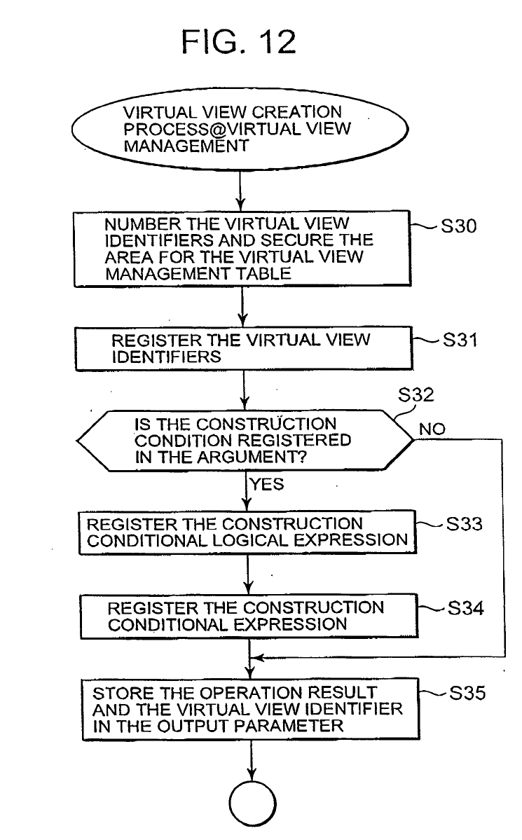

As the result of determination, when the accepted operation request is the virtual view creation request 3110, the virtual view I/F control program 192 calls the virtual view management program 191, and allows the virtual view management program 191 to execute the virtual view creation process (S21) . Furthermore, the process at S21 will be described later in FIG. 12.

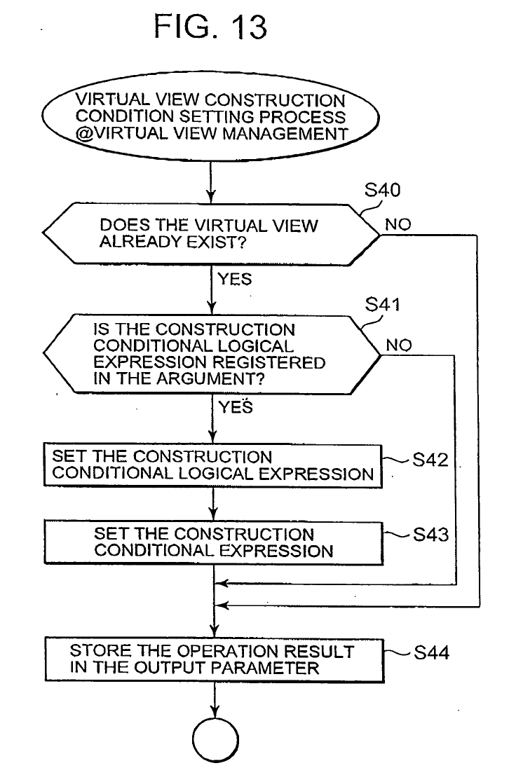

As the result of determination, when the accepted operation request is the virtual view construction condition setting request 3120, the virtual view I/F control program 192 calls the virtual view management program 191 and allows the virtual view management program 191 to execute the virtual view construction condition setting process (S22). Moreover, the process at S22 will be described later in FIG. 13.

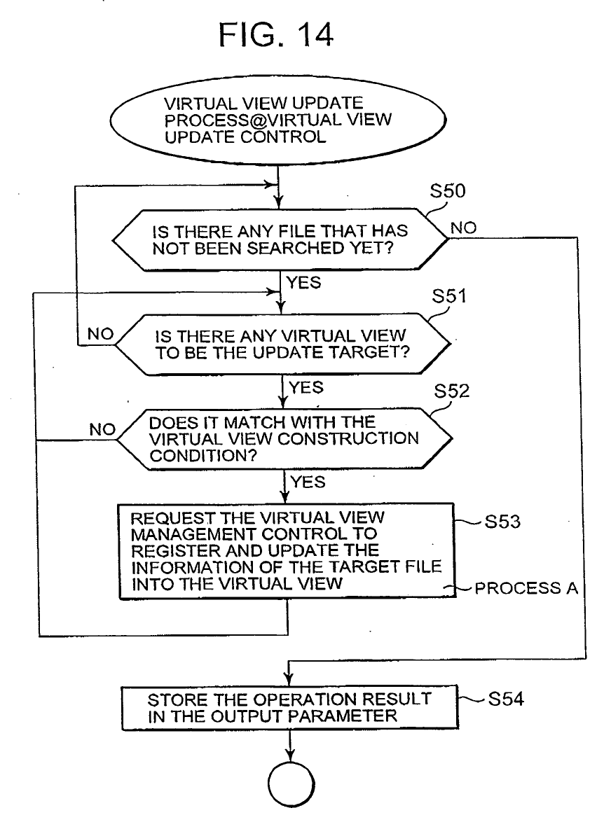

As the result of determination, when the accepted operation request is the virtual view update request 3130, the virtual view I/F control program 192 calls the virtual view update control program 193, and allows the virtual view update control program 193 to execute the virtual view update process (S23). In addition, the process at S23 will be described later in FIG. 14.

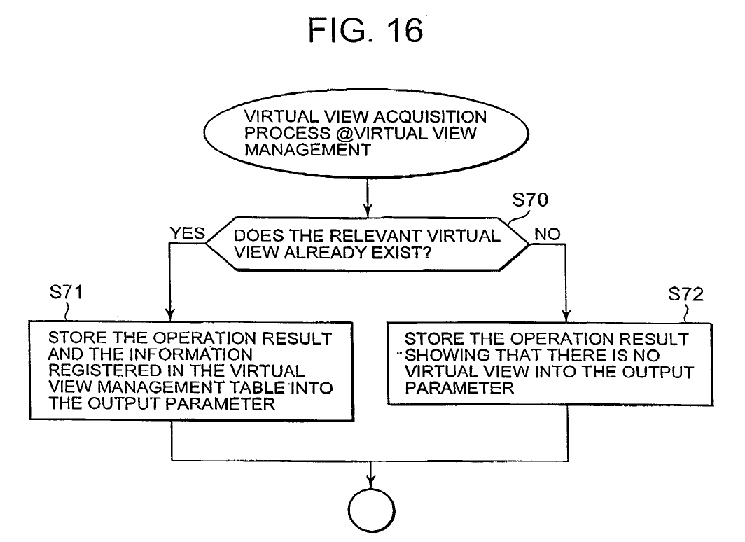

As the result of determination, when the accepted operation request is the virtual view acquisition request 3140, the virtual view I/F control program 192 calls the virtual view management program 191, and allows the virtual view management program 191 to execute the virtual view acquisition process (S24). Furthermore, the process at S24 will be described later in FIG. 16.

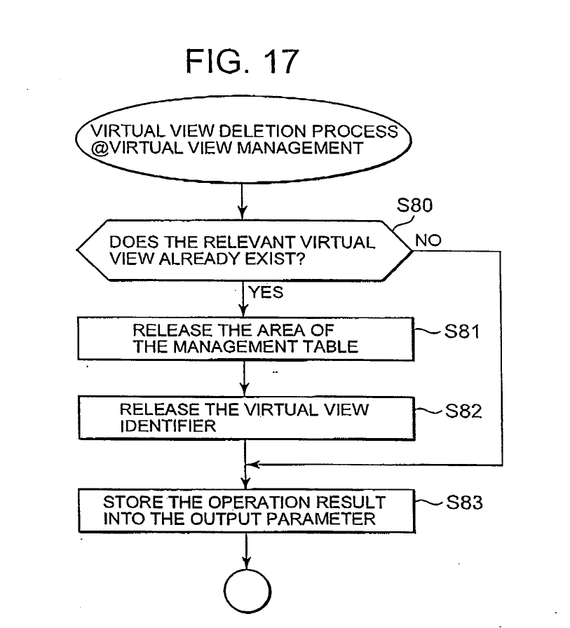

Moreover, as the result of determination, when the accepted operation request is the virtual view deletion request 3150, the virtual view I/F control program 192 calls the virtual view management program 191, and allows the virtual view management program 191 to execute a virtual view deletion process (S25). In addition, the process at S24 will be described later in FIG. 17.

At S21 to 25, the individual processes are finished, and then return to the process of the virtual view I/F control program 192 to be the caller.

Next, the virtual view creation process done by the control server 100 of the embodiment will be described with reference to FIG. 12.

FIG. 12 is a flow chart for describing the virtual view creation process done by the control server 100 of the embodiment.

In addition, the process below is implemented by executing the virtual view management program 191 by the processor 110 of the control server 100. However, the virtual view management program 191 is mainly described below for simplifying the description.

After called by the virtual view I/F control program 192 at S21 in FIG. 11, the virtual view management program 191 numbers the virtual view identifiers to secure the area for the virtual view management table 2000 on the memory 120 that the virtual view uses (S30). Here, the unique identifiers of the virtual view identifiers are numbered. The range to insure the uniqueness of the virtual view identifier is not limited particularly. For example, the uniqueness may be insured in a single control server. Furthermore, for example, a control server group that a plurality of control servers is grouped or the entire world may be formed as a single range to insure the uniqueness.

Subsequently, the virtual view management program 191 stores the virtual view identifiers numbered at S30 in the entry 2100 of the virtual view management table 2000 (see FIG. 3) on the area of the memory 120 having been secured at S30 (S31).

After that, the virtual view management program 191 determines whether the construction condition is registered in the information 5130 required for the individual operations of the input parameter 5100 (see FIG. 7) that is set as the argument in the accepted virtual view operation request accepted at S20 (S32).

As the result of determination, the virtual view management program 191 proceeds to the process at S33 when the construction condition is registered in the information 5130 required for the individual operations in the input parameter 5100, whereas it proceeds to the process at S35 when the information is not registered.

At S33, the virtual view management program 191 stores the construction conditional logical expression in the registered construction conditions into the entry 2300 of the virtual view management table 2000, and proceeds to S34.

At S34, the virtual view management program 191 stores the construction conditional expression in the registered construction conditions into the entry 2400 of the virtual view management table 2000, and proceeds to S35. In addition, when there is a plurality of construction conditional expressions, the construction conditional expressions are stored in the matching entry (for example, the entry 2500) by that number.

At S35, the virtual view management program 191 creates the output parameter 5200 (see FIG. 7). More specifically, the virtual view management program 191 registers the operation result into the ‘operation result 5210’ of the output parameter 5200, that is, the information showing whether the virtual view creation process is successful or failed. Furthermore, the virtual view management program 191 registers the virtual view identifier of the created virtual view into the ‘information 5220 obtained by the operation’ of the output parameter 5200 (registers the virtual view identifier stored in the virtual view management table 2000). After that, the virtual view management program 191 returns to the process of the virtual view I/F control program 192 to be the caller.

Next, the virtual view construction condition setting process done by the control server 100 of the embodiment will be described with reference to FIG. 13.

FIG. 13 is a flow chart for describing the virtual view construction condition setting process done by the control server 100 of the embodiment.

In addition, the process below is implemented by executing the virtual view management program 191 by the processor 110 of the control server 100. However, the virtual view management program 191 is mainly described below for simplifying the description.

At S22 in FIG. 11, after called by the virtual view I/F control program 192, the virtual view management program 191 checks the virtual view identifier 5120 in the input parameter 5100 (see FIG. 7) set as the argument in the virtual view operation request against the virtual view management table 2000 held in the memory 120 (or the external storage unit 130) . Then, the virtual view management program 191 examines whether there is the virtual view having the virtual view identifier 5120 specified by the input parameter 5100 (S40).

More specifically, the virtual view management program 191 examines whether there is the virtual view management table 2000 where the virtual view identifier 5120 specified in the input parameter 5100 is stored therein. The virtual view management program 191 proceeds to S41 when there is the virtual view management table 2000 where the virtual view identifier 5120 specified in the input parameter 5100 is stored therein. On the other hand, the virtual view management program 191 proceeds to S44 when there is not the virtual view management table 2000 where the virtual view identifier 5120 specified in the input parameter 5100 is stored therein.

At S41, the virtual view management program 191 examines the information 4130 required for the individual operations in the input parameter 5100 set as the argument of the virtual view operation request, and examines whether the construction condition 2200 for the corresponding virtual view is registered (S41). Subsequently, the virtual view management program 191 proceeds to the process at S42 when the construction condition 2200 is registered. The virtual view management program 191 proceeds to the process at S44 when the construction condition 2200 is not registered.

At S42 to S43, the virtual view management program 191 performs the same processes as those shown at S33 to S34 in FIG. 12, and proceeds to the process at S44. Furthermore, at S42 to S43, in setting the construction condition 2200 by the virtual view management program 191, the construction condition might be already registered in the relevant entry of the virtual view management table 2000. In this case, the virtual view management program 191 performs the overwrite process with respect to the information already registered. Moreover, in overwriting the construction condition 2200, the virtual view management program 191 may overwrite all the target entries of the construction conditional logical expression and the construction conditional expressions, or overwrites only a part of the entries.

At S44, as similar to S35 in FIG. 12, the virtual view management program 191 creates the output parameter 5200 (see FIG. 7). For example, at S40, when the virtual view management program 191 determines that there is not the virtual view to be the target for the operation request, it registers information showing that the requested process is failed because there is not-the virtual view into the operation result 5210 of the output parameter 5200. After that, the virtual view management program 191 returns to the process of the virtual view I/F control program 192 to be the caller.

Next, the virtual view update process done by the control server 100 of the embodiment will be described with reference to FIG. 14.

FIG. 14 is a flow chart for describing the virtual view update process done by the control server 100 of the embodiment.

In addition, the process below is implemented by executing the individual programs (the virtual view update control program 193, the file system control program 180, and the virtual view management program 191) by the processor 110 of the control server 100. However, the individual programs (the virtual view update control program 193, the file system control program 180, and the virtual view management program 191) are mainly described below for simplifying the description.

The process steps to be performed below are the process that is started when the virtual view update control program 193 is called by the virtual view I/F control program 192 at S23. The virtual view update control program 193 allows the file system control program 180 to examine a file group already stored in the storage nodes 500a to 500n. Then, the virtual view update control program 193 performs the process of reflecting the information of the files matching with the construction conditions of the entries 2200 of the virtual view management table 2000 managed by the virtual view management program 191 in the virtual view management table 2000. That is, in the steps, the virtual view update process is performed that is triggered by the update request from the user as a cue.

Here, any methods are acceptable to examine the file group, such as exclusive search and partial search. When partial search is done, it is necessary to specify the search range separately in the information 5130 required for the individual operations in the input parameter 5100 set as the argument in the operation request. The search order is freely set, but not falls in an endless loop.

First, the virtual view update control program 193 allows the file system control program 180 to examine whether there is any file that has not been searched yet in the file group to be the search target (S50). The virtual view update control program 193 proceeds to S54 when the file system control program 180 finishes searching for the entire file group to be the search target. On the other hand, the virtual view update control program 193 proceeds to S51 when the file system control program 180 detects the file that has not been searched yet.

At S54, the virtual view update control program 193 registers the operation result into the operation result 5210 of the output parameter 5200, and returns to the process of the virtual view I/F control program 192 to be the caller.

At S51, the virtual view update control program 193 uses the virtual view management table 2000 to confirm whether there is a virtual view that is an update target and is not yet verified with the detected file (351). In addition, verification is confirmation whether there is a virtual view that requires update by the detected file. The virtual view update control program 193 proceeds to the process at S52 when it detects the virtual view that is the update target and is not yet verified with the detected target file. On the other hand, the virtual view update control program 193 returns to the process at 350 when it does not detect the virtual view that is not yet verified with the detected target file. Here, any methods and procedures are acceptable to examine the target virtual view for update as similar to the manner to examine the file group.

At S52, the virtual view update control program 193 confirms whether the target file matches with the construction condition 2200 of the virtual view detected at S51 (S52) Subsequently, the virtual view update control program 193 proceeds to the process at S53 when the target file matches with the construction condition of the virtual view. The virtual view update control program 193 returns to the process at S51 when the target file does not match with the construction condition of the virtual view.

At S53, the virtual view update control program 193 requests the virtual view management program 191 to perform the process (process A) to register and update the information of the target file into the virtual view management table 2000 (S53). In requesting the process A, the virtual view update control program 193 delivers the virtual view identifier of the virtual view to be the process target and file identification information as the input parameters to the virtual view management program 191. Here, the file identification information is considered to include the file name of the file and the stored location of the registered file. Furthermore, the flow of the process A will be described later. After the process A is finished, the virtual view update control program 193 returns to the process at step S51. Moreover, the process flow above is repeated until the examination of the search target file is finished.

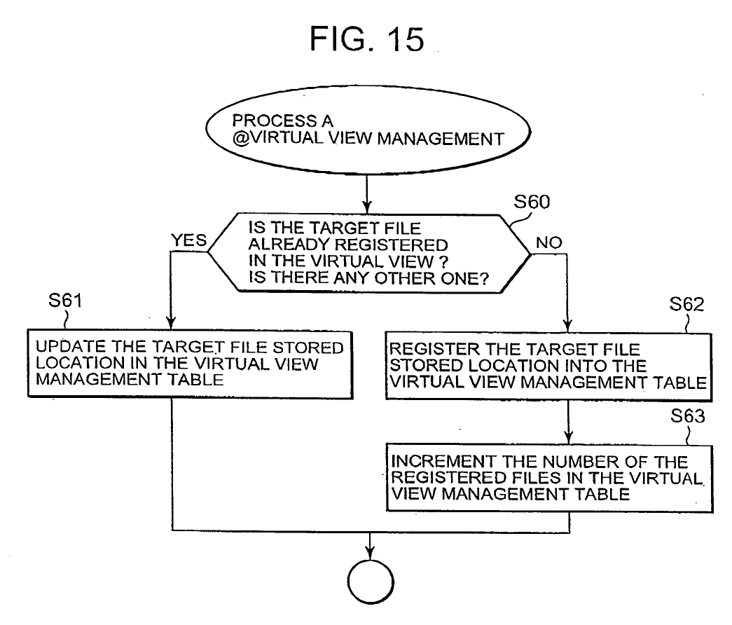

Next, the flow of the process A shown at S53 in FIG. 14 will be described with reference to FIG. 15.

FIG. 15 is a flow chart for describing an information registration process and update process for the virtual view management table done by the control server of the embodiment.

In addition, the process below is implemented by executing the individual programs (the virtual view management program 191 and the virtual view update control program 193) by the processor 110 of the control server 100. However, the individual programs (the virtual view management program 191 and the virtual view update control program 193) are mainly described below for simplifying the description.

The virtual view management program 191 is called by the virtual view update control program 193 at S53 in FIG. 14, and starts the process steps below. In the process steps below, the virtual view management program 191 performs the process in which the information of the file specified by the argument is registered and updated into the virtual view management table 2000 where the virtual view identifier is stored therein that is specified by the argument of the input parameter obtained at S53.

First, the virtual view management program 191 specifies the virtual view management table 2000 (see FIG. 3) where the virtual view identifier is stored therein that is specified by the argument of the input parameter obtained at S53 in FIG. 14. The virtual view management program 191 determines whether the file stored location included in the identification information of the file specified by the argument of the input parameter is already registered in the entries 2700a to 2700n of the virtual view management table 2000 (S60).

When it determines that the target file is already registered by the determination at S60, the virtual view management program 191 overwrites the file stored location already registered and updates the virtual view management table 2000 (S61)

On the other hand, when it determines that the target file is not registered by the determination at S60, it registers the stored location of the target file into the relevant entry (for example, the entry 2700) of the registered file stored location in the virtual view management table 2000 (S62) , and increments the value of the entry 2600 where the number of the registered files of the virtual view management table 2000 is stored (S63).

Next, the virtual view acquisition process done by the control server 100 of the embodiment will be described with reference to FIG. 16.

FIG. 16 is a flow chart for describing the virtual view acquisition process done by the control server 100 of the embodiment.

In addition, the process below is implanted by executing the virtual view management program 191 by the processor 110 of the control server 100. However, the virtual view management program 191 is mainly described below for simplifying the description.

At S24 in FIG. 11, the virtual view management program 191 is called by the virtual view I/F control program 192, and starts the virtual view acquisition process, which will be described below. In the virtual view acquisition process, the process is performed that provides information of the virtual view management table 2000 having the virtual view identifier specified by the input parameter. Here, for the format to provide the information, any methods are acceptable such as a method which provides all the data of the virtual view management table 2000 of the virtual view and a method which provides a part thereof.

The virtual view management program 191 first examines the virtual view identifier 5120 of the input parameter 5100 (see FIG. 7) set as the argument in the virtual view operation request, and uses the examined identifier 5120 and the virtual view management table 2000 to determine whether there is the virtual view having the relevant virtual view identifier (S70).

When the virtual view management program 191 determines that there is the virtual view having the virtual view identifier, it stores the operation result of this operation in the operation result 5310 of the output parameter 5300. Here, the operation result stores the message showing that the requested virtual view acquisition process is successful, that is, it stores the information showing that the virtual view requested by the virtual view operation request is found. Furthermore, the virtual view management program 191 stores the information registered in the virtual view management table 2000 of the relevant virtual view into the information 5320 obtained by the operation of the output parameter 5300, and returns to the process of the virtual view I/F control program 192 to be the caller (S71).

On the other hand, when the virtual view management program 191 determines that there is no virtual view having the virtual view identifier, it stores the message showing that the requested virtual view acquisition process is failed in the operation result 5210 of the output parameter 5200, that is, it stores the message showing that there is no virtual view requested by the virtual view operation request as the operation result, and returns to the process of the virtual view I/F control program 192 to be the caller (S72).

Moreover, in the description above, the example is taken that the virtual view identifier is specified in the input parameter 5100 that is set as the argument in the virtual view operation request accepted from the user, but the invention is not defined thereto particularly. For example, in the virtual view operation request accepted from the user, it is fine to accept the construction condition (information of the entry 2200 of the virtual view management table 2000) instead of the virtual view identifier. Then, it is acceptable that the virtual view management program 191 searches for the relevant virtual view in accordance with the accepted construction condition.

Next, the virtual view deletion process done by the control server 100 of the embodiment will be described with reference to FIG. 17.

FIG. 17 is a flow chart for describing the virtual view deletion process done by the control server 100 of the embodiment.

In addition, the process below is implemented by executing the virtual view management program 191 by the processor 110 of the control server 100. However, the virtual view management program 191 is mainly described below for simplifying the description.

At S25 in FIG. 11, the virtual view management program 191 is called by the virtual view I/F control program 192, and starts the virtual view deletion process, which will be described below. In the virtual view deletion process, the process is performed in which the area of the virtual view management table 2000 of the virtual view specified by the input parameter is released to delete the registered information, and release the relevant virtual view identifier.

The virtual view management program 191 first examines the virtual view identifier 5120 of the input parameter 5100 (see FIG. 7) set as the argument in the virtual view operation request, and uses the examined virtual identifier 5120 and the virtual view management table 2000 to determine whether there is the virtual view having the virtual view identifier 5120 included in the input parameter 5100 (380).

When the virtual view management program 191 determines that there is the virtual view having the virtual view identifier 5120 included in the input parameter 5100, it releases the area of the virtual view management table 2000 of the virtual view (S81), releases the virtual view identifier, and proceeds to the process at S83 (S82).

On the other hand, at S80, when the virtual view management program 191 determines that there is no virtual view having the virtual view identifier 5120 of the input parameter 5100, it proceeds to the process at S83.

At S83, the virtual view management program 191 registers the operation result of this operation into the operation result 5210 of the output parameter 5200, and returns to the process of the virtual view I/F control program 192 to be the caller.

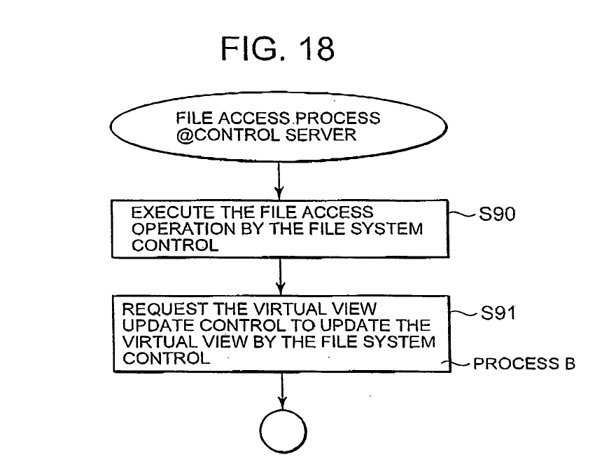

Next, the virtual view update process will be described with reference to FIG. 18, which is done by the control server 100 of the embodiment as the file access operation is a cue.

FIG. 18 is a flow chart for describing the virtual view update process done by the control server 100 of the embodiment as the file access operation is a cue.

When the client nodes 200a to 200n request the file access operation for the files stored in the storage nodes 500a to 500n, the client nodes 200a to 200n request the file access operation with respect to the control server 100 by the file system access control program 280. Upon receiving the request from the client nodes 200a to 200n, the control server 100 makes access to the files stored in the storage nodes 500a to 500n, and sends the result of the access process back to the client nodes 200a to 200n. Then, the control server 100 performs the process to update the virtual view when it performs the file access operation. Hereinafter, the file access operation will be described, including the virtual view update process in the control server 100.

In addition, the process below is implemented by executing the individual programs (the file system control program 180 and the virtual view update control program 193) by the processor 110 of the control server 100. However, the individual programs (the file system control program 180 and the virtual view update control program 193) are mainly described below for simplifying the description.

The file system control program 180 of the control server 100 accepts the file access operation request from the file system access control program 280 of the client nodes 200a to 200n. Then, the file system control program 180 executes the accepted file access operation (S90).

When the file access operation is finished, the file system control program 180 requests the virtual view update control program 193 for the process (process B) in order to reflect the target file in the virtual view (S91).

In requesting the process B, the file system control program 180 delivers identification information about a process target file and identification information about the file access operation for the target file as the input parameter to the virtual view update control program 193. Furthermore, the flow of the process B will be described later. When the process B is finished, the file system control program 180 returns the result of the file access operation to the file system access control program 280 of the client node 200.

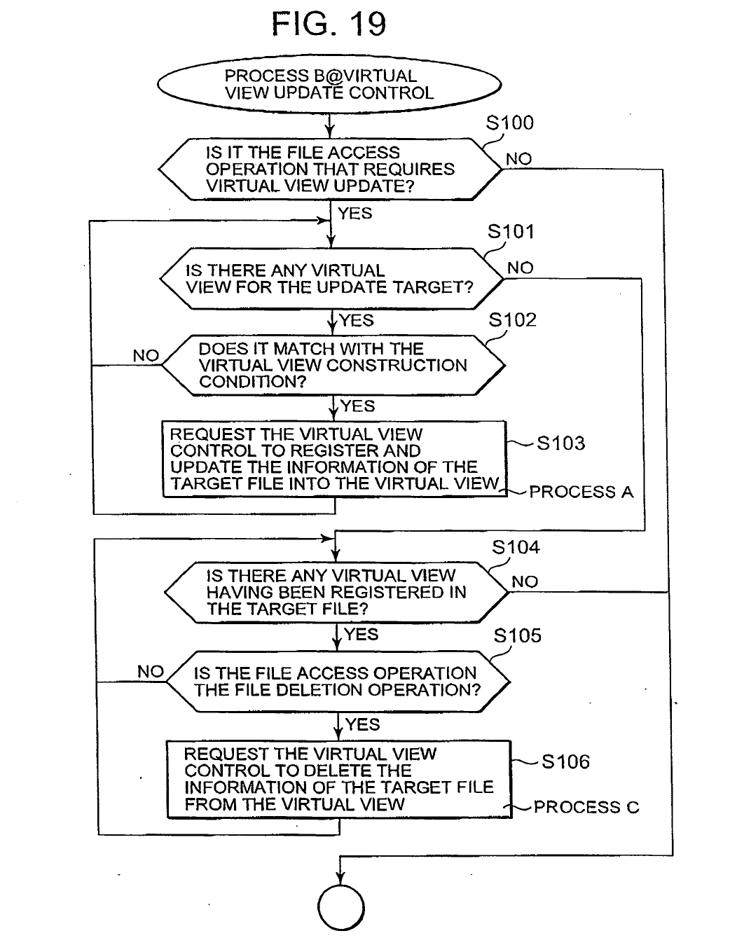

Next, the flow of the process B shown at S91 in FIG. 18 will be described with reference to FIG. 19.

FIG. 19 is a flow chart for describing the virtual view update process done by the control server 100 of the embodiment as the file access operation is a cue.

In addition, the process below is implemented by executing the individual programs (the virtual view management program 191 and the virtual view update control program 193) by the processor 110 of the control server 100. However, the individual programs (the virtual view management program 191 and the virtual view update control program 193) are mainly described below for simplifying the description.

At S91 in FIG. 18, the virtual view update control program 193 starts the process steps below when it accepts the request for the process B (the process to reflect the target file in the virtual view) from the file system control program 180. In the process B, the virtual view update control program 193 extracts the virtual view having the construction condition matching with the target file specified by the input parameter obtained at S91 from the virtual view management table 2000. Then, the virtual view update control program 193 performs the process to reflect the information of the target file in the extracted virtual view. Hereinafter, the detail will be described.

The virtual view update control program 193 first uses identification information about the file access process specified by the input parameter obtained at S91, and determines whether the file access operation shown by the identification information is the process that the virtual view requires update (S100). Furthermore, the determination at S100 is done based on the classification information shown in FIG. 8. That is, the virtual view update control program 193 determines that the virtual view requires update when the file access operation is the file write operation or the file deletion operation. On the other hand, the virtual view update control program 193 determines that the virtual view does not require update when the file access operation is the file readout operation.

Subsequently, the virtual view update control program 193 proceeds to the process at S101 when it determines that the virtual view requires update. On the other hand, the virtual view update control program 193 ends the process when it determines that the that the virtual view does not require update, and returns to the process of the file system control program 180 to be the caller.

At S101 to S103, the virtual view update control program 193 sets the file specified by the input parameter obtained at S91 as the target file, and performs the same processes as those at S51 to S53 in FIG. 14.

More specifically, at S101, the virtual view update control program 193 uses the virtual view management table 2000, and confirms whether there is the virtual view that is for the update target and is not verified with the file (target file) to be the target for the access operation specified by the input parameter. Here, any methods and procedures are acceptable to examine the target virtual view. The virtual view update control program 193 proceeds to the process at S102 when it detects the virtual view that has not been verified with the target tile. The virtual view update control program 193 proceeds to the process at S104 when it does not detect the virtual view that has not been verified with the target file, that is, when it verifies all the virtual views.

At S102, the virtual view update control program 193 determines whether the target file for the file access operation matches with the construction condition of the detected virtual view. The virtual view update control program 193 proceeds to S103 when the target file for the file access operation matches with the construction condition of the detected virtual view. On the other hand, the virtual view update control program 193 returns to the process at S101 when the file does not match.

At S103, the virtual view update control program 193 requests the virtual view management program 191 to perform the process (process A) to register and update the information of the target file to the virtual view management table 2000 (S103). In requesting the process A, it delivers the virtual view identifier to be the process target and the file identification information as the input parameters to the virtual view management program 191. Furthermore, the flow of the process A is as shown in FIG. 15. When the process A is finished, the virtual view update control program 193 returns to the process at step S101. Moreover, the virtual view update control program 193 repeats the process flow (S101 to 103) until it examines all the virtual views held therein.

Next, the process at S104 will be described, to which the virtual view update control program 193 proceeds when it finishes the examination of all the target virtual views.

At S104, the virtual view update control program 193 uses the input parameter obtained at S91 and the virtual view management table 2000 to examine whether there is the virtual view that registers the target file having undergone the access operation (S104).

When there is the virtual view that registers the target file having undergone the access operation, the virtual view update control program 193 determines whether identification information about the file access process specified by the input parameter is the file deletion process (S105).

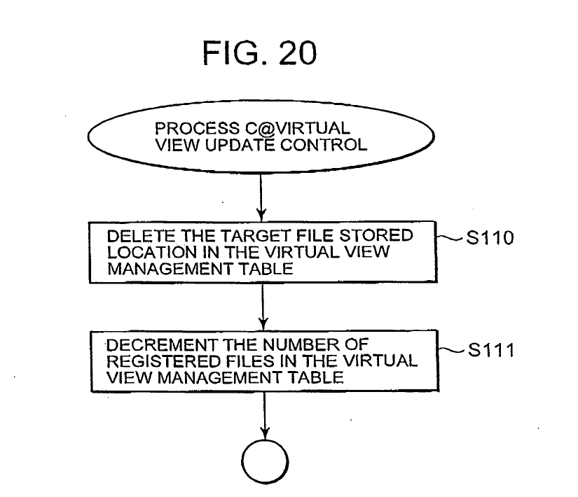

As the result of the determination at S105, when the identification information is the file deletion process, the virtual view update control program 193 requests the virtual view management program 191 to perform the process (process C) to delete the information of the target file in the virtual view management table 2000 (S106) In requesting the process C, it delivers the virtual view identifier to be the process target and the file identification information as the input parameters to the virtual view management program 191. In addition, the flow of the process C will be described later in FIG. 20. When the process C is finished, it returns to the process at S104.

As the result of the determination at S105, it again performs the process at S104 when the identification information is not the file deletion process. Furthermore, the process flow at S104 to S106 is repeated until all the virtual views finish the examination.

Next, the flow of the process C shown at S106 in FIG. 19 will be described with reference to FIG. 20.

FIG. 20 is a flow chart for describing the process done by the control server of the embodiment to delete information from the virtual view management table.

In addition, the process below is implemented by executing each of the individual programs (the virtual view management program 191 and the virtual view update control program 193) by the processor 110 of the control server 100. However, the individual programs (the virtual view management program 191 and the virtual view update control program 193) are mainly described bellow for simplifying the description.

At S106 in FIG. 19, the virtual view management program 191 is called by the virtual view update control program 193, and starts the process C, which will be described below. In the process C, the process is performed in which the information of the file specified by the argument is deleted from the virtual view management table 2000 having the virtual view identifier specified by the argument of the input parameter obtained at S106.

The virtual view management program 191 first deletes the target file stored location information specified by the argument of the input parameter from the entry 2700 of the registered file stored location in the virtual view management table 2000 having the virtual view identifier specified by the argument (S110). Furthermore, the virtual view management program 191 decrements the number of registered files stored in the entry 2600 of the virtual view management table 2000 (S111).

In this manner, in the embodiment, the current virtual view can be provided all the time by performing the virtual view update triggered by the file access operation shown in FIG. 19 as a cue.

Moreover, in the case where the virtual view is updated only when the file access operation is performed, it is impossible to reflect information about the file stored and updated in the file system before the construction condition for the virtual view is set. On this account, in the embodiment, the virtual view update is performed that is triggered by the request from the user as a cue as shown in FIG. 14, in addition to the virtual view update triggered by the file access operation as a cue. Accordingly, it is possible to reflect information about the file stored and registered in the storage node in the virtual view before the construction condition for the virtual view is set.

In addition, the present invention is not limited to the embodiment described above, which can be modified variously in the scope of the teachings of the present invention. For example, embodiments 2 to 5 are feasible below.

### Second Embodiment

In the first embodiment described above, the stored location information about the file 7000 matching with the construction condition for the virtual view can be registered into the virtual view 3000, but the present invention is not limited thereto. Information may be different from the information about the stored locations of information resources when it matches with the construction condition 2200 for the virtual view. For example, in order to hierarchically manage a plurality of virtual views, information about the virtual view 3000 matching with the construction condition 2200 for the virtual view is registered into the entry 2700 where the stored locations of information resources are registered. More specifically, the virtual view identifier of the target virtual view for registration is registered into the entry 2700 where information about the registered file location of the virtual view management table 2000 is stored therein. In this case, the number of files registered only in the relevant virtual view may be registered into the entry 2600 where the number of registered files is stored therein, or the number of all the files registered in the virtual view and in the virtual view in the lower layer may be registered.

The layering of the virtual view 3000 is implemented in this manner, and thus the user can manage the virtual view 3000 hierarchically. Moreover, in the second embodiment, not only the virtual view 3000 matching with the construction condition 2200 of the virtual view but also those that group information resources such as a folder or a directory that groups a plurality of files may be registered.

### Third Embodiment

In the first embodiment, the control server 100 provides the virtual view 3000 by the function provided by the virtual view control program 190, but the present invention is not limited thereto.

The virtual view 3000 through the function to make access to information resources held by the control server 100 may be utilized. For example, the control server 100 may provide the virtual view 300b for the user by the file system control program 180. In this case, the control server 100 may manage the virtual view management table 2000 of the virtual view 3000 as a file or a directory by the file system control program 180 and may access to the virtual view management table 2000.

Accordingly, the file corresponding to the virtual view management table 2000 can be read out by the file read operation 6120 provided by the file system control program 180, or alternatively the directory corresponding to the virtual view management table 2000 can be read out by the directory information read operation.

In this manner, instead of utilizing the function exclusive for the virtual view provided by the virtual view control program 190, the function of utilizing the virtual view is added to the general function to provide the following advantage. More specifically, since the user can utilize the virtual view during the operation of the file access function used in the general work by configuring the third embodiment, the operational effort of the user can be reduced.

In addition, in the third embodiment, instead of the method which utilizes the virtual view by the function provided by the file access control program 180, the virtual view through the access function to the other information resources, such as the function of controlling the access to the data base may be utilized.

### Fourth Embodiment

In the first embodiment described above, the user of the client nodes 200a to 200n utilizes the virtual view 3000, but the present invention is not limited thereto. A storage operation control unit which operates and manages the storage nodes 500a to 500n may be provided to allow the storage operation control unit to utilize the virtual view 3000.

For example, the storage nodes of the control target are registered into the storage operation control unit. The storage operation control unit creates virtual views by the number of those registered storage nodes based on the registered information. The storage operation control unit may set the condition that registers files stored in the storage nodes corresponding to the virtual views into the virtual views as the construction condition for the individual virtual views. More specifically, the storage operation control unit can confirm the files stored in the storage nodes as the virtual views at every the storage node.

The storage operation control unit is allowed to utilize the virtual view like this, and thus the storage operation control unit can promptly obtain the list of the files stored in the storage nodes as the virtual view. Accordingly, when a certain storage node needs to be physically replaced, the target files for data transfer to another storage node and for backup can be specified promptly. Therefore, the processing time required for these processes can be accelerated.

Furthermore, in the fourth embodiment, in addition to the aspect that the storage nodes for the control target are registered into the storage operation control unit, the storage operation control unit may be allowed to register other information required for storage operation control and to construct the virtual view based on the information for use in the storage operation control.

### Fifth Embodiment

Moreover, the configuration task may be done with respect to the storage operation control unit which operates and manages the storage nodes 500a to 500n of the fourth embodiment and the contents are reflected in the virtual view 3000. For example, user information (identification information that identifies a user) is registered on an operation terminal of the storage operation control unit, and this user information is utilized for the virtual view management process by the control server 100. Accordingly, the access control function to the virtual view 3000 can be further added to the virtual view providing system 1000 in the embodiments described above. More specifically, the authority over the virtual view creation request 3110, the authority over the virtual view construction condition setting request 3120, the authority over the virtual view update request 3130, the authority over the virtual view acquisition request 3140, and the authority over the virtual view deletion request 3150 can be controlled based on the function provided by the virtual view I/F control program 192. Furthermore, the user information is managed by the virtual view management table 2000 corresponding to the individual virtual views 3000, and thus the access control described above can be implemented at every virtual view.

For example, the control server 100 accepts and holds user identification information showing a user and the setting of access authority information given to that user as the information is associated with the user identification information. Then, when the control server 100 accepts the virtual view acquisition request 3140 from a user, it requests identification information that identifies the user through the client node 200. The control server 100 changes the contents of the virtual view shown by the access authority information associated with the accepted user identification information.

In the description above, the user information is registered for the purpose of access control, but the present invention is not limited thereto. For example, group information may be registered as the access control information, or list information that describes the authorization to a target user or target group like the access control list may be registered.

The upper limit value of the number of virtual views to be created may be registered on the operation terminal of the storage operation control unit and may manage the upper limit value by the function provided by the virtual view management program 191 of the control server 100. Accordingly, the upper limit value of the virtual views to be created and provided by the control server 100 can be controlled. Besides, the upper limit value of the virtual views to be created is set at every user by the operation terminal and managed by the virtual view management program 191. Thus, the upper limit value of the virtual views that individual users are able to create can be controlled.

A function to obtain list information about the virtual views existing at present may be provided as the virtual view acquisition request 3140 provided by the virtual view I/F control program 192. Then, this function is utilized on the operation terminal of the storage operation control unit, and thus the list information about the virtual views created by the control server 100 can be obtained from the storage operation control unit. The acquisition of the list information about the virtual views allows the manager and the user to know information that how many virtual views can be created after this from the comparison with information that how many virtual views have been created at present, or with the upper limit value of the virtual views to be created.

What is claimed is:

1. A computer which is connected to one or more of storage devices through a network and performs access control over the storage device, the computer comprising:
means which accepts a classification condition for file data stored in the storage device;
means which searches for file data satisfying the classification condition from the file data stored in the storage device, and creates and stores information that is associated with a file name and a stored location of the file data satisfying the classification condition at every classification condition (hereinafter, called to as “virtual view information”);
means which accepts a presentation request for the virtual view information from a user, and represents the stored virtual view information;
means which accepts an access request for the file data stored in the storage device from a user, and performs an access process with respect to the file data in the storage device; and
means which updates the stored virtual view information when the access process is done with respect to the file data.

2. The computer according to claim 1, wherein when an access process is done with respect to the file data, the update means determines whether the access process is a write process or a deletion process for the file data, and updates the stored virtual view information when the process is either the write process or the deletion process.

3. The computer according to claim 2, wherein when the access process is determined as the write process for the file data and there is the virtual view information having the classification condition matching with the file data that has undergone the write process in the stored virtual view information, the update means associates the file name and the stored location of the file data that has undergone the write process with the classification condition of the virtual view information, and
when the access process is determined as the deletion process for the file data and there is the virtual view information that is associated with the file name of the file data that has undergone the deletion process in the stored virtual view information, the update means deletes the file name and the stored location of the file data that is associated with the classification condition of the virtual view information and has undergone the deletion process.

4. The computer according to claim 1, wherein the file data stored in the storage device includes attribute information containing a file name, a file creation date, a file creator, and a file stored location, and
the classification condition is anyone of the attribute information, or a combination of any of the attribute information.

5. The computer according to claim 1, further comprising means which accepts user identification information showing a user and access authority information that is given to that user in association with the user identification information,
wherein in accepting a presentation request for virtual view information from a user, the means which represents virtual view information accepts input of the user identification information, and changes contents of the virtual view shown by the access authority information associated with the user identification information.

6. The computer according to claim 1, further comprising:
means which creates list information about the stored virtual view information; and
means which accepts a list information presentation request from a user, and represents the list information.

7. A computer which is connected to one or more of storage devices through a network and performs access control over the storage device, the computer comprising:
means which accepts a classification condition for file data stored in the storage device, and creates and stores information that includes the classification condition at every accepted classification condition (hereinafter, called to as “virtual view information”);
means which accepts an access request for the file data stored in the storage device from a user, and performs an access process with respect to the requested file data;
update means which determines whether there is the virtual view information including the classification condition matching with the accessed file data in the stored virtual view information when the access process is done with respect to the file data, and the update means which associates a file name and a stored location of the accessed file data with the virtual view information including the classification condition matching with the accessed file data when there is the virtual view information; and
means which accepts a presentation request for virtual view information from a user, and represents the stored virtual view information.

8. The computer according to claim 7, further comprising means which accepts a virtual view update request from a user,
wherein when the virtual view update request is accepted, the update means determines whether there is the virtual view information having the classification condition matching with the file data stored in the storage device in the stored virtual view information, and
when there is the virtual view information having the classification condition matching with the stored file data, the update means associates the file name and the stored location of the matched file data with the virtual view information.

9. The computer according to claim 7, wherein the file data stored in the storage device includes attribute information containing a file name, a file creation date, a file creator, and a file stored location, and
the classification condition is anyone of the attribute information, or a combination of any of the attribute information.

10. The computer according to claim 9, wherein the file data stored in the storage device includes actual file information about the file data, and
the classification condition is a keyword contained in the actual file information, or a keyword contained in the actual file information, and a combination of any of the attribute information.

11. The computer according to claim 7, further comprising means which accepts user identification information showing a user and access authority information that is given to that user in association with the user identification information,
wherein in accepting a presentation request for virtual view information from a user, the means which represents virtual view information accepts input of the user identification information, and changes contents of the virtual view shown by the access authority information associated with the user identification information.

12. The computer according to claim 7, further comprising:
means which creates list information about the stored virtual view information; and
means which accepts a list information presentation request from a user, and represents the list information.

13. A storage system comprising:
one or more of storage devices; and
a computer which performs access control over the storage device,
wherein the storage device is connected to the computer through a network,
the storage device comprises:
means which stores file data having attribute information including a file name, a file creation date, a file creator, and a file stored location; and
means which accept an access request from the computer, and performs input/output processes for the stored file data with respect to the computer, and
the computer comprises:
means which accepts anyone of the attribute information about the file data stored in the storage device, or information that combines any of the attribute information as a classification condition;
means which searches for file data satisfying the accepted classification condition from the file data stored in the storage device, and creates and stores information that is associated with a file name and a stored location of the file data satisfying the classification condition at every classification condition (hereinafter, called to as “virtual view information”);
means which accepts a presentation request for the virtual view information from a user, and represents the stored virtual view information;
means which accepts an access request for the file data in the storage device from the user, and performs an access process with respect to the file data in the storage device; and
means which updates the stored virtual view information when the access process is done with respect to the file data.

14. The storage system according to claim 13, wherein when the access process is done with respect to the file data, the update means determines whether the access process is a write process or a deletion process for the file data, and
when the process is either the write process or the deletion process, the update means updates the stored virtual view information.

15. A file management method done by a computer which is connected to one or more of storage devices through a network and performs access control over the storage device,
wherein the computer has a storage unit,
wherein the computer executes the steps of:
accepting a classification condition for file data stored in the storage device;
searching for file data satisfying the classification condition from the file data stored in the storage device, and creating and storing information that is associated with a file name and a stored location of the file data satisfying the classification condition at every classification condition (hereinafter, called to as “virtual view information”) in the storage unit;
accepting a presentation request for virtual view information from a user, and representing the stored virtual view information in the storage unit;
accepting an access request for the file data stored in the storage device from a user, and performing an access process with respect to the file data in the storage device; and
updating the virtual view information stored in the storage unit when the access process is done with respect to the file data.

16. The file management method done by the computer according to claim 15, wherein in the update step,
when an access process is done with respect to the file data, it is determined whether the access process is a write process or a deletion process for the file data, and
when the process is either the write process or the deletion process, the virtual view information stored in the storage unit is updated.

17. A program which allows a computer to perform a process of managing file data stored in a storage system, the storage system including one or more of storage devices and a computer which performs access control over the storage device,
wherein the computer has a storage unit,
wherein the program allows the computer to execute the steps of;
accepting a classification condition for file data stored in the storage device;
searching for file data satisfying the classification condition from the file data stored in the storage device, creating information that is associated with a file name and a stored location of the file data satisfying the classification condition at every classification condition (hereinafter, called to as “virtual view information”), and creating and storing the virtual view information in the storage unit;
accepting a presentation request for virtual view information from a user, and representing the virtual view information stored in the storage unit;
accepting an access request for the file data stored in the storage device from a user, and performing an access process with respect to the file data in the storage device; and
updating the virtual view information stored in the storage unit when the access process is done with respect to the file data.
